(19) United States
(12) Patent Application Publication
(10) Pub. No.: US 2012/0075536 A1
(43) Pub. Date: Mar. 29, 2012

(54) Display Device, Liquid Crystal Display Device, Method For Driving Display Device, And Television Receiver

(75) Inventors: Kazuhiro Uehara, Osaka (JP); Tomoyuki Ishihara, Osaka (JP)

(73) Assignee: SHARP KABUSHIKI KAISHA, Osaka-shi, Osaka (JP)

(21) Appl. No.: 13/322,968

(22) PCT Filed: Feb. 16, 2010
(86) PCT No.: PCT/JP2010/000946

§ 371 Date: Nov. 29, 2011

(30) Foreign Application Priority Data
Jun. 9, 2009 (JP) 2009-138558

(51) Int. Cl. H04N 5/50; G09G 3/36; G09G 5/10

(52) U.S. Cl. 348/731; 345/690; 345/102; 348/E05.097

(57) ABSTRACT

A display device includes: an area active backlight; a backlight control section determining and controlling light intensity of each illumination area according to input data DF; and a sub-frame data generating section generating sub-frame data according to the determined light intensity. In at least one example embodiment, one frame is divided into first and second sub-frames, and the sub-frame data generating section generates first and second sub-frame data such that at one of adjacent pixels, display luminance during the first sub-frame is not higher than display luminance during the second and at the other, display luminance during the second sub-frame is not higher than display luminance during the first. Display is performed as a sum of these displays. This provides a display device capable of simultaneously achieving improvement in moving image quality, reduction in power consumption, and improvement in display quality due to reduction in flickers.

### TECHNICAL FIELD

The present invention relates to a display device (e.g. liquid crystal display device) capable of displaying frames in such a manner that each frame is the sum total of a plurality of sub-frames.

### BACKGROUND ART

Conventionally, attentions have been paid to viewing angle characteristics in liquid crystal panels. Specifically, luminance differs between when a liquid crystal panel is seen from a skew direction and when the liquid crystal panel is seen from a front direction. In a case of a VA mode liquid crystal panel in particular, a difference between luminance to be displayed originally (expected luminance) and actually displayed luminance (actual luminance) is 0 when luminance is minimum (minimum tone) or maximum (maximum tone) and the difference is maximum when luminance is intermediate luminance (halftone), as shown in FIG. 19. Such a phenomenon is generally referred to as “excess luminance (excess brightness)”.

The principle of how excess luminance (excess brightness) occurs is briefly explained below with reference to FIG. 20. (a) of FIG. 20 shows display luminance of input image data. (b) of FIG. 20 shows light intensity per one frame of an illumination area. (c) of FIG. 20 shows supposed light transmittance of liquid crystal in a display area. (d) of FIG. 20 shows luminance when a liquid crystal panel is seen from a front direction and luminance when the liquid crystal panel is seen from a skew direction. In a case where a bright portion and a dark portion coexist in an illumination area, there may occur excess brightness in the dark portion when the liquid crystal panel is seen from a skew direction, as shown in (d) of FIG. 20.

A technique of subduing excess luminance (excess brightness) is disclosed in Patent Literatures 1 and 2. A liquid crystal display device disclosed in Patent Literature 1 is designed such that one frame is divided into a plurality of sub-frames (e.g. first sub-frame and second sub-frame) and input data is displayed as the sum total of displays of the plurality of sub-frames. How the liquid crystal display device disclosed in Patent Literature 1 displays is shown in (a)-(c) of FIG. 21. Here, it is assumed that input data has minimum display luminance of 0 to maximum display luminance of 100.

As shown in (a) of FIG. 21, when it is assumed that input data has display luminance of 80, a backlight (BL) is caused to emit light with constant intensity during one frame period (light intensity of 100 per one frame), and light transmittance is set to be 60% in the first sub-frame and 100% in the second sub-frame.

Further, as shown in (b) of FIG. 21, when it is assumed that input data has display luminance of 60, a backlight is caused to emit light with constant intensity during one frame period (light intensity of 100 per one frame), and light transmittance is set to be 20% in the first sub-frame and 100% in the second sub-frame.

Further, as shown in (c) of FIG. 21, when it is assumed that input data has display luminance of 10, a backlight is caused to emit light with constant intensity during one frame period (light intensity of 100 per one frame), and light transmittance is set to be 0% in the first sub-frame and 20% in the second sub-frame.

This configuration enables reducing a difference in halftone luminance (halftone) as shown in FIG. 22, thereby reducing excess luminance.

### CITATION LIST

### Patent Literatures

### [Patent Literature 1]

Japanese Patent Application Publication No. 2005-173573 (published on Jun. 30, 2005)

### [Patent Literature 2]

Japanese Patent Application Publication No. 2005-234552 (published on Sep. 2, 2005)

### [Patent Literature 3]

Japanese Patent Application Publication No. 2008-64997 (published on Mar. 21, 2008)

### SUMMARY OF INVENTION

### Technical Problem

However, such sub-frame display suffers a problem as follows: one of the plurality of sub-frames (first sub-frame in the above example) is a dark sub-frame for almost all input data, but emission from the backlight is constant during one frame period, so that the dark sub-frame becomes excessively bright due to light leakage etc. and the effect of sub-frame display is reduced. Further, such sub-frame display suffers a problem of wasteful power consumption since emission from the backlight is constant regardless of whether the sub-frame is a dark sub-frame or a bright sub-frame.

A technique of overcoming these problems is disclosed in Patent Literature 3. FIG. 23 is a block diagram schematically showing a configuration of a liquid crystal display device disclosed in Patent Literature 3. This liquid crystal display device 110 is designed such that there are provided a plurality of illumination areas, light intensities of the illumination areas are controlled individually, and light transmittances of individual sub-frames are set depending on the light intensities. This liquid crystal display device is explained below with a specific example.

Initially, a backlight control section obtains display luminance of frame data DF. It is assumed that a display area HAR0 (see FIG. 2) of a liquid crystal panel includes a part showing the moon with display luminance of 80 and a background part (part showing the sky) with display luminance of 60. In this case, the supposed maximum display luminance is 80, and accordingly the backlight control section determines that light intensity per one frame of an illumination area LAR0 (see FIG. 3) of an area active backlight which illumination area LAR0 corresponds to the display area HAR0 is 80. That is, the backlight control section determines that the period of emission of the illumination area LAR0 is 0.8 frame, emission is not made during 0.2 frame from the start of the frame, and emission is made during the remaining 0.8 frame.

For the part with supposed display luminance of 80 in the display area HAR0, first sub-frame data DSF1 indicative of light transmittance of 100% and second sub-frame data DSF2 indicative of light transmittance of 100% are generated. During 0.2 frame from the start of the frame, since emission from the illumination area LAR0 is not made, display luminance is 0 even when light transmittance of the display area HAR0 is set to 100%. Further, during the remaining 0.8 frame, since emission from the illumination area LAR0 is made, the display luminance is 100 when the light transmittance of the display area HAR0 is 100%. This is schematically shown in (a) of FIG. 24, which shows that sub-frame display can be made while reducing light intensity of the illumination area LAR0.

For the part with supposed display luminance of 60 in the display area HAR0, first sub-frame data DSF1 indicative of light transmittance of 33% and second sub-frame data DSF2 indicative of light transmittance of 100% are generated. During 0.2 frame from the start of the frame, since emission from the illumination area LAR0 is not made, display luminance is 0 even when light transmittance of the display area HAR0 is set to 33%. Further, during the remaining 0.8 frame, since emission from the illumination area LAR0 is made, the display luminance is 33 when the light transmittance of the display area HAR0 is 33% and the display luminance is 100 when the light transmittance of the display area HAR0 is 100%. This is schematically shown in (b) of FIG. 24, which shows that sub-frame display can be made while reducing light intensity of the illumination area LAR0.

The above configuration enables improvement in display quality of a liquid crystal display device, reduction in power consumption, and improvement in moving image quality.

However, the liquid crystal display devices disclosed in Patent Literatures 1 and 3 suffer a problem that flickers are more likely to be observed due to a difference in luminance between sub-frames, since sub-frame display is made with respect to the whole display plane of the liquid crystal panel. For example, as shown in FIG. 25, in a liquid crystal panel driven at 60 Hz per one frame, if display luminance is set at 120 Hz, i.e. set for each of a first sub-frame (dark sub-frame) and a second sub-frame (bright sub-frame), luminance difference (brightness and darkness) between the first sub-frame and the second sub-frame is more likely to be observed upon seeing a display plane as a whole.

As described above, a conventional display device which makes sub-frame display is inferior in terms of display quality due to flickers, compared with a normal display device which makes frame display. That is, it is difficult to realize a display device which is superior in terms of all of moving image quality, power consumption, and display quality due to reduction in flickers than a display device which makes frame display.

The present invention was made in view of the foregoing problems. An object of the present invention is to provide a display device capable of improving moving image quality, reducing power consumption, and improving display quality by reducing flickers.

### Solution to Problem

In order to solve the foregoing problem, a display device of the present invention is a display device, which generates, from input data, a plurality of sub-frame data respectively corresponding to a plurality of sub-frames obtained by dividing one frame, and which displays the input data as a sum of displays of the plurality of sub frame data, the display device including: a backlight including a plurality of illumination areas and capable of individually controlling light intensities of the plurality of illumination areas according to input data; a backlight control section for determining light intensity of each of the illumination areas according to input data to a display area corresponding to said each of the illumination areas and controlling the light intensity of said each of the illumination areas; and a sub-frame data generating section for generating the plurality of sub-frame data according to the light intensity of each of the illumination areas determined by the backlight control section, one frame being divided into a first sub-frame and a second sub-frame, the sub-frame data generating section generating first sub-frame data and second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

With the display device carrying out sub-frame display, for example, at a first pixel, a first half of a frame is a dark sub-frame and a second half of the frame is a bright sub-frame, whereas at a second pixel adjacent to the first pixel, the first half of the frame is a bright sub-frame and the second half of the frame is a dark sub-frame. Consequently, a difference between (i) an average of display luminances (brightness and darkness) on the whole of a display plane of a display panel in the first half of one frame and (ii) an average of display luminances (brightness and darkness) on the whole of the display plane of the display panel in the second half of the frame is smaller than that in the case of carrying out the sub-frame display on the whole of the display plane of the display panel (see FIG. 25). Consequently, luminance difference between sub-frames is less likely to be observed.

Consequently, the display device yields not only the effects of improving moving image quality and reducing power consumption due to sub-frame display but also the effect of improving display quality due to reduction in flickers. That is, the display device can simultaneously achieve improvement in moving image quality, reduction in power consumption, and improvement in display quality due to reduction in flickers.

In order to solve the foregoing problem, a display device of the present invention is a display device, including: a backlight including a plurality of illumination areas and capable of individually controlling light intensities of the plurality of illumination areas according to input data; a display luminance determining section for determining whether a difference between maximum display luminance and minimum display luminance of input data per one frame to each of display areas respectively corresponding to the illumination areas is larger than a predetermined threshold or not; a backlight control section for determining light intensity of each of the illumination areas according to input data per one frame to a display area corresponding to said each of the illumination areas and controlling the light intensity of said each of the illumination areas; and a sub-frame data generating section for generating, from input data, a plurality of sub-frame data respectively corresponding to a plurality of sub-frames obtained by dividing one frame, the generating being made according to a result of determination by the display luminance determining section and the light intensity of each of the illumination areas determined by the backlight control section, in a case where the difference between maximum display luminance and minimum display luminance of input data per one frame to the display area is larger than the threshold, a plurality of sub-frame data with different display luminances for the display area being generated from the input data according to the light intensity of each of the illumination areas determined by the backlight control section, and the input data being displayed as a sum of displays of the generated plurality of sub-frame data, and in a case where the difference between maximum display luminance and minimum display luminance of input data per one frame to the display area is not larger than the threshold, a plurality of sub-frame data with equal display luminance for the display area being generated from the input data according to the light intensity of each of the illumination areas determined by the backlight control section, and the input data being displayed as a sum of displays of the generated plurality of sub-frame data.

With the arrangement, with respect to a display area where a difference between maximum display luminance and minimum display luminance (luminance difference) of input data is larger than the predetermined threshold out of a plurality of display areas, light intensity of a corresponding illumination area is controlled to be intensity sufficient for display at the display area, and based on the controlled light intensity, a plurality of sub-frame data are generated such that individual sub-frames have different display luminances, and display is performed as a sum of these sub-frame data (luminance dividing sub-frame display). On the other hand, with respect to a display area where the luminance difference is not larger than the predetermined threshold, the luminance dividing sub-frame display is not carried out and instead a plurality of sub-frame data is generated such that individual sub-frames have equal display luminance and display is performed as a sum of these sub-frame data (luminance equalizing sub-frame display).

The threshold is a value serving as a reference for determining whether excess luminance appears or not. For example, assume that when a difference in luminance (light transmittance) between a bright part and a dark part in input data to a display area is 20%, excess luminance does not appear, and when the difference is more than 20%, excess luminance appears. In this case, the threshold is set to 20%. The threshold is determined according to optical characteristics of a liquid crystal panel in use and an optical system of a backlight in use.

That is, with the arrangement, with respect to a display area where excess luminance is likely to appear, the luminance dividing sub-frame display is carried out, whereas with respect to a display area where excess luminance is less likely to appear, the luminance equalizing sub-frame display is carried out. consequently, a luminance difference between sub-frames is less likely to be observed compared with a display state where the sub-frame display (luminance dividing sub-frame display) is carried out on the whole of a display plane of a display panel (see FIG. 25). Consequently, the display device yields not only the effects of improving moving image quality and reducing power consumption due to the luminance dividing sub-frame display but also the effect of improving display quality due to reduction in flickers. That is, the display device can simultaneously achieve improvement in moving image quality, reduction in power consumption, and improvement in display quality due to reduction in flickers.

In order to solve the foregoing problem, a method of the present invention for driving a display device is a method for driving a display device which includes a backlight including a plurality of illumination areas and capable of individually controlling light intensities of the plurality of illumination areas according to input data and which generates, from input data, a plurality of sub-frame data respectively corresponding to a plurality of sub-frames obtained by dividing one frame, and which displays the input data as a sum of displays of the plurality of sub frame data, the method including: a backlight control step of determining light intensity of each of the illumination areas according to input data to a display area corresponding to said each of the illumination areas and controlling the light intensity of said each of the illumination areas; and a sub-frame data generating step of generating the plurality of sub-frame data according to the light intensity of each of the illumination areas determined in the backlight control step, one frame being divided into a first sub-frame and a second sub-frame, in the sub-frame data generating step, first sub-frame data and second sub-frame data being generated in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

The method yields the effects yielded by the display device of the present invention.

In order to solve the foregoing problem, a method of the present invention for driving a display device is a method for driving a display device including a backlight including a plurality of illumination areas and capable of individually controlling light intensities of the plurality of illumination areas according to input data, the method including: a display luminance determining step of determining whether a difference between maximum display luminance and minimum display luminance of input data per one frame to each of display areas respectively corresponding to the illumination areas is larger than a predetermined threshold or not; a backlight control step of determining light intensity of each of the illumination areas according to input data per one frame to a display area corresponding to said each of the illumination areas and controlling the light intensity of said each of the illumination areas; and a sub-frame data generating step of generating, from input data, a plurality of sub-frame data respectively corresponding to a plurality of sub-frames obtained by dividing one frame, the generating being made according to a result of determination in the display luminance determining step and the light intensity of said each of the illumination areas determined in the backlight control step, in a case where the difference between maximum display luminance and minimum display luminance of input data per one frame to the display area is larger than the threshold, a plurality of sub-frame data with different display luminances for the display area being generated from the input data according to the light intensity of said each of the illumination areas determined in the backlight control step, and the input data being displayed as a sum of displays of the generated plurality of sub-frame data, and in a case where the difference between maximum display luminance and minimum display luminance of input data per one frame to the display area is not larger than the threshold, a plurality of sub-frame data with equal display luminance for the display area being generated from the input data according to the light intensity of said each of the illumination areas determined in the backlight control step, and the input data being displayed as a sum of displays of the generated plurality of sub-frame data.

The method yields the effects yielded by the display device of the present invention.

### Advantageous Effects of Invention

As described above, the display device of the present invention and the method of the present invention for driving the display device are designed to carry out the sub-frame display such that one of adjacent pixels is in a dark sub-frame, the other is in a bright sub-frame. Further, another display device of the present invention and the method of the present invention for driving another display device are designed such that the luminance dividing sub-frame display is carried out with respect to only a part where excess luminance is likely to appear. This enables simultaneously achieving improvement in moving image quality, reduction in power consumption, and improvement in display quality due to reduction in flickers.

### BRIEF DESCRIPTION OF DRAWINGS

FIG. 1 is a block diagram schematically showing a configuration of a liquid crystal display device in accordance with First Embodiment.

FIG. 2 is a drawing schematically showing a configuration of a display section of the liquid crystal display device.

FIG. 3 is a drawing schematically showing a configuration of an area active backlight.

FIG. 4 is a drawing showing a state where excess luminance appears.

FIG. 5 is a drawing showing a display state per 120 Hz in driving of 60 Hz per one frame.

FIG. 6 is a drawing for explaining a process of partially carrying out sub-frame display. (a) of FIG. 6 shows a part where excess luminance (excess brightness) is likely to appear due to large luminance difference. (b) of FIG. 6 shows a state in the first half of one frame (first sub-frame) of the part where excess luminance is likely to appear. (c) of FIG. 6 shows a state in the second half of one frame (second sub-frame) of the part where excess luminance is likely to appear. (d) of FIG. 6 shows a display state per one frame which is a sum total of the display in (b) and the display in (c).

FIG. 7 (a), (b), and (c) of FIG. 7 are drawings schematically showing an example of setting an area active backlight and an example of generating sub-frame data in a liquid crystal display device in accordance with First Example in First Embodiment.

FIG. 8 is a drawing schematically showing an example of setting an area active backlight and an example of generating sub-frame data in the liquid crystal display device in accordance with First Example in First Embodiment.

FIG. 9 (a) and (b) of FIG. 9 are drawings schematically showing an example of setting an area active backlight and an example of generating sub-frame data in the liquid crystal display device in accordance with First Example in First Embodiment.

FIG. 10 (a) and (b) of FIG. 10 are drawings schematically showing an example of setting an area active backlight and an example of generating sub-frame data in the liquid crystal display device in accordance with First Example in First Embodiment.

FIG. 11 is a block diagram schematically showing a configuration of a liquid crystal display device in accordance with Second Embodiment.

FIG. 12 is a drawing schematically showing how to drive pixels in a liquid crystal panel in the liquid crystal display device in accordance with Second Embodiment. (a) of FIG. 12 shows how to drive pixels in an odd frame (first frame, third frame, fifth frame, . . . ), and (b) of FIG. 12 shows how to drive pixels in an even frame (second frame, fourth frame, sixth frame, . . . ).

FIG. 13 is a drawing visually showing how to drive pixels in the liquid crystal panel in accordance with FIG. 12. (a) of FIG. 13 shows an odd frame (first frame, third frame, fifth frame, . . . ) and (b) of FIG. 13 shows an even frame (second frame, fourth frame, sixth frame, . . . ).

FIG. 14 is a drawing showing display states per 120 Hz (sub-frame) in driving of 60 Hz per one frame in the liquid crystal display device in accordance with Second Embodiment.

FIG. 15 is a drawing schematically showing how to drive pixels in a liquid crystal panel in another liquid crystal display device in accordance with Second Embodiment. (a) of FIG. 15 shows how to drive pixels in an odd frame (first frame, third frame, fifth frame, . . . ), and (b) of FIG. 15 shows how to drive pixels in an even frame (second frame, fourth frame, sixth frame, . . . ).

FIG. 16 is a block diagram schematically showing a configuration of a liquid crystal display device in accordance with Third Embodiment.

FIG. 17 is a drawing for explaining a process of partially carrying out sub-frame display while switching dark sub-frame data and bright sub-frame data with each other with respect to each of adjacent pixels in the liquid crystal display device in accordance with Third Embodiment. (a) of FIG. 17 shows a part where excess luminance (excess brightness) is likely to appear due to large luminance difference. (b) of FIG. 17 shows a state in the first half of one frame (first sub-frame) of the part where excess luminance is likely to appear. (c) of FIG. 17 shows a state in the second half of one frame (second sub-frame) of the part where excess luminance is likely to appear. (d) of FIG. 17 shows a display state per one frame which is a sum total of the display in (b) and the display in (c).

FIG. 18 is a block diagram explaining a function of a television receiver of the present invention.

FIG. 19 is a graph showing a relationship between expected luminance and actual luminance in a conventional liquid crystal display device.

FIG. 20 is a drawing explaining the principle of excess luminance. (a) of FIG. 20 shows display luminance of input image data. (b) of FIG. 20 shows light intensity per one frame of an illumination area. (c) of FIG. 20 shows supposed light transmittance of liquid crystal in a display area. (d) of FIG. 20 shows luminance when a liquid crystal panel is seen from a front direction and luminance when the liquid crystal panel is seen from a skew direction.

FIG. 21 (a)-(c) of FIG. 21 are drawings schematically showing an example of setting an area active backlight and an example of generating sub-frame data in a conventional liquid crystal display device.

FIG. 22 is a graph showing a relationship between expected luminance and actual luminance in a conventional liquid crystal display device.

FIG. 23 is a block diagram schematically showing a configuration of a conventional liquid crystal display device.

FIG. 24 (a) and (b) of FIG. 24 are drawings schematically showing an example of setting an area active backlight and an example of generating sub-frame data in the liquid crystal display device shown in FIG. 23.

FIG. 25 is a drawing showing display states per 120 Hz in driving of 60 Hz per one frame in a conventional liquid crystal display device.

FIG. 26 (a)-(c) of FIG. 26 are drawings schematically showing an example of setting an area active backlight and an example of generating sub-frame data in the liquid crystal display device in accordance with Second Example in First Embodiment.

FIG. 27 (a) and (b) of FIG. 27 are drawings schematically showing an example of setting an area active backlight and an example of generating sub-frame data in the liquid crystal display device in accordance with Second Example in First Embodiment.

FIG. 28 is a block diagram schematically showing a configuration of a liquid crystal display device in accordance with Fourth Embodiment.

FIG. 29 is a flowchart showing an example of an operation of the liquid crystal display device in accordance with Fourth Embodiment.

### DESCRIPTION OF EMBODIMENTS

### First Embodiment

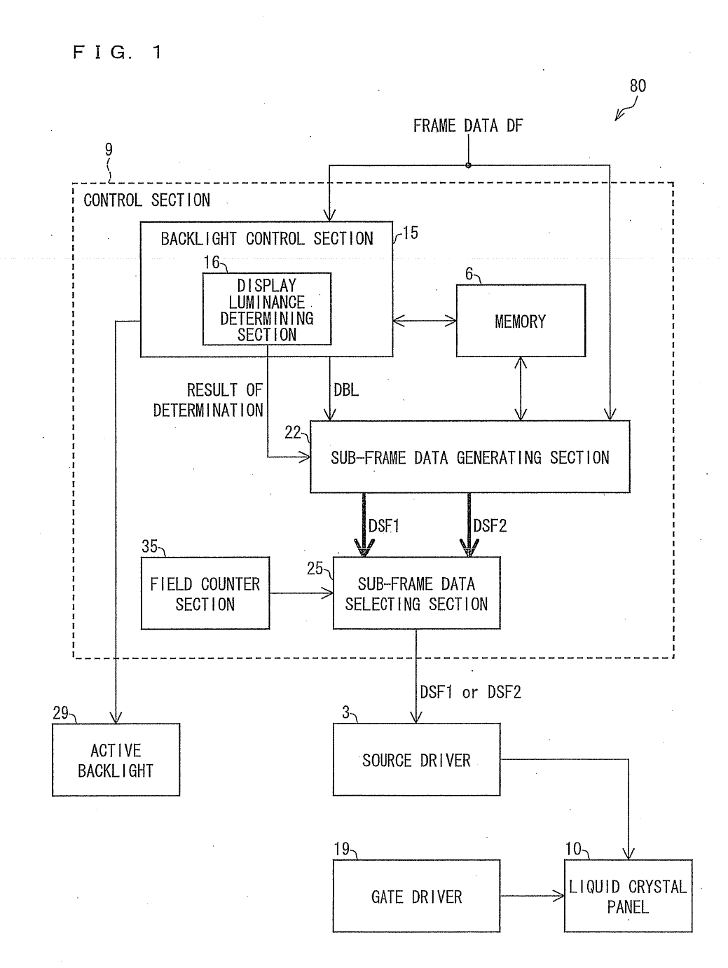

The following explains one embodiment of the liquid crystal display device of the present invention. FIG. 1 is a block diagram showing a configuration of a liquid crystal display device in accordance with the present embodiment. As shown in FIG. 1, a liquid crystal display device 80 in accordance with the present embodiment includes an area active backlight (active backlight, backlight) 29, a liquid crystal panel 10, a gate driver 19, a source driver 3, and a control section 9. The liquid crystal panel 10 may be combined integrally with individual drivers (source driver 3 and gate driver 19).

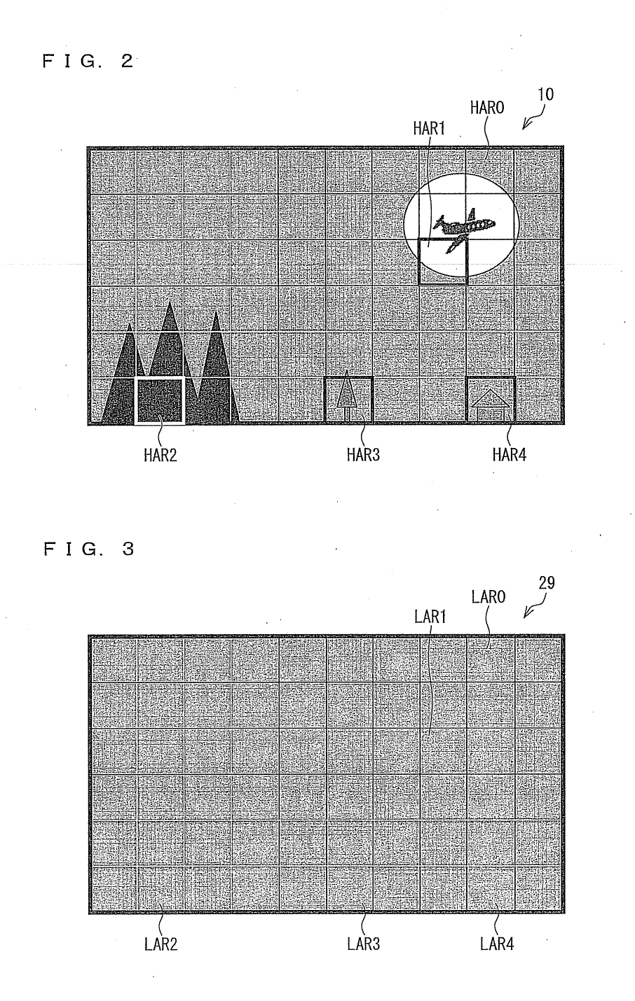

As shown in FIG. 3, the area active backlight 29 includes a plurality of illumination areas LAR, and each illumination area LAR is designed such that light intensity per one frame can be controlled individually. As shown in FIG. 2, the liquid crystal panel 10 includes, in its display section, a plurality of display areas HAR respectively corresponding to illumination areas LAR of the area active backlight 29. For example, a display area HAR1 of the liquid crystal panel 10 corresponds to an illumination area LAR1 of the area active backlight 29.

The control section 9 of the liquid crystal display device 80 in accordance with the present embodiment includes a memory 6, a backlight control section 15, a sub-frame data generating section 22, a sub-frame data selecting section 25, and a field counter section 35. The backlight control section 15 includes a display luminance determining section 16. To the backlight control section and the sub-frame data generating section 22 is inputted frame data (input data) DF. The frame data DF is RGB data. Although not shown in the drawings, the control section 9 includes a timing control section to which a vertical sync signal, a horizontal sync signal, a dot clock etc. are inputted. The timing control section controls the backlight control section 15, the sub-frame data generating section 22, the sub-frame data selecting section 25, the gate driver 19 etc.

The backlight control section 15 calculates, from all frame data DF included in a display area HAR, maximum display luminance and minimum display luminance which are supposed in the display area HAR, and the display luminance determining section 16 determines whether a difference between the maximum display luminance and the minimum display luminance (luminance difference) is larger than a predetermined threshold or not (display luminance determining step). The display luminance determining section 16 outputs the result of determination to the sub-frame data generating section 22. The threshold is a value serving as a reference for determining whether excess luminance appears or not. Since the threshold depends on optical characteristics of a liquid crystal panel in use and an optical system of a backlight in use, the threshold is evaluated and determined in individual systems and stored in the memory 6.

Further, the backlight control section 15 determines light intensity per one frame of an illumination area LAR corresponding to the display area HAR in accordance with the maximum display luminance (backlight control step), and outputs the determined light intensity as data DBL to the sub-frame data generating section 22. Further, the backlight control section 15 regulates (sets) light intensity per one frame of the illumination area LAR in accordance with the determined light intensity (backlight control step). In the liquid crystal display device 80 in accordance with the present embodiment, illumination luminances of individual illumination areas LAR are made constant, and light intensities per one frame of individual illumination areas LAR are regulated by changing an emission time in one frame (i.e. during what percentage of one frame emission is made).

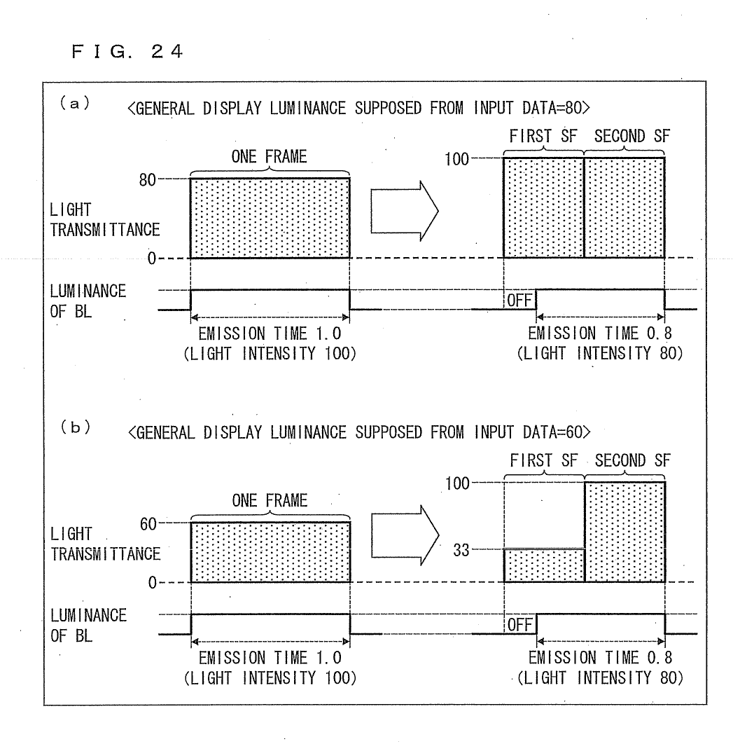

The sub-frame data generating section 22 generates sub-frame data in accordance with the result of determination by the display luminance determining section 16 (frame data generating step). That is, when the difference between the minimum display luminance and the maximum display luminance (luminance difference) is larger than the predetermined threshold, it is highly likely that excess luminance appears. Accordingly, in order to carry out sub-frame display shown in FIG. 24, sub-frame data (DSF1 and DSF2) is generated. Specifically, the sub-frame data generating section 22 generates first sub-frame data DSF1 and second sub-frame data DSF2 in accordance with the frame data DF and the light intensity (data DBL) per one frame of the illumination area LAR which is determined by the backlight control section 15. It should be noted that the first sub-frame data DSF1 and the second sub-frame data DSF2 are generated in such a manner that the first sub-frame and the second sub-frame have different display luminances. In the present embodiment, such sub-frame display is referred to as “luminance dividing sub-frame display”. That is, “luminance dividing sub-frame display” indicates a display method in which one frame is divided into a plurality of sub-frames (e.g. first sub-frame and second sub-frame), luminances of individual sub-frames are differentiated from each other (i.e. one of the sub-frames is provided with increased luminance) and input data is displayed as the sum total of displays of the plurality of sub-frames.

On the other hand, when the difference between the minimum display luminance and the maximum display luminance (luminance difference) is not larger than the predetermined threshold, it is less likely that excess luminance appears. Accordingly, the “luminance dividing sub-frame display” is not carried out. That is, the sub-frame data generating section 22 generates sub-frame data as follows in accordance with the result of determination by the display luminance determining section 16 (frame data generating step). That is, the sub-frame data generating section 22 generates first sub-frame data DSF1 and second sub-frame data DSF2 in accordance with the frame data DF and the light intensity (data DBL) per one frame of the illumination area LAR determined by the backlight control section 15 in such a manner that the first sub-frame and the second sub-frame have the same display luminance. In the present embodiment, such sub-frame display in which luminance is not divided is referred to as “luminance equalizing sub-frame display”. That is, “luminance equalizing sub-frame display” indicates a display method in which one frame is divided into a plurality of sub-frames (e.g. first sub-frame and second sub-frame), luminances of individual sub-frames are made equal to each other (i.e. neither of the sub-frames is provided with increased luminance) and input data is displayed as the sum total of displays of the plurality of sub-frames.

The first sub-frame data DSF1 and the second sub-frame data DSF2 which have been generated by the sub-frame data generating section 22 are inputted to the sub-frame data selecting section 25. The sub-frame data selecting section 25 switches the first sub-frame data DSF1 and the second sub-frame data DSF2 at double speed (e.g. 120 Hz). The field counter section 35 determines whether in a first sub-frame or a second sub-frame, and outputs the result of determination to the sub-frame data selecting section 25.

In accordance with the result of determination by the field counter section 35, the sub-frame data selecting section 25 outputs the first sub-frame data DSF1 to the source driver 3 at start timing of the first sub-frame, and outputs the second sub-frame data DSF2 to the source driver 3 at start timing of the second sub-frame.

The source driver 3 converts the sub-frame data DSF1 and DSF2 into analog potential signals, and drives individual source lines (data signal lines) of the liquid crystal panel 10 using the potential signals. Further, the gate driver 19 drives gate lines (scanning signal lines) of the liquid crystal panel 10 using well-known control signals outputted from the control section 9.

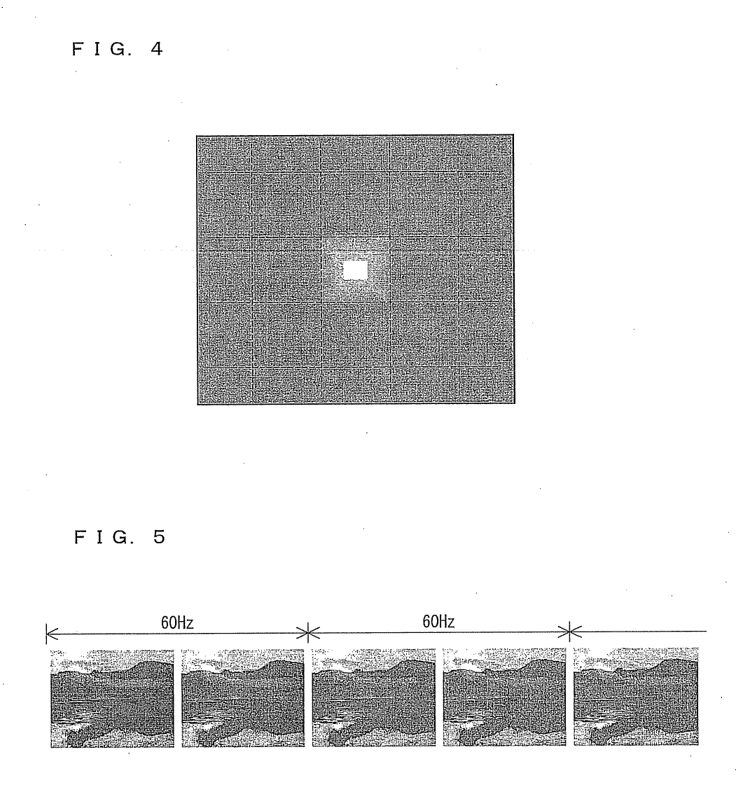

As described above, the liquid crystal display device 80 in accordance with the present embodiment is designed such that the “luminance dividing sub-frame display” is carried out with respect to the display area HAR only when the difference between the maximum display luminance and the minimum display luminance of the frame data DF in the display area HAR is larger than the threshold. That is, whether to carry out the “luminance dividing sub-frame display” or the “luminance equalizing sub-frame display” is set with respect to each of the display areas HAR. FIG. 4 shows a state where excess luminance (excess brightness) appears in one frame. With the configuration of the liquid crystal display device 80 of the present invention, the “luminance dividing sub-frame display” is carried out with respect to the central display area HAR in which excess brightness appears, and the “luminance equalizing sub-frame display” is carried out with respect to other display areas HAR.

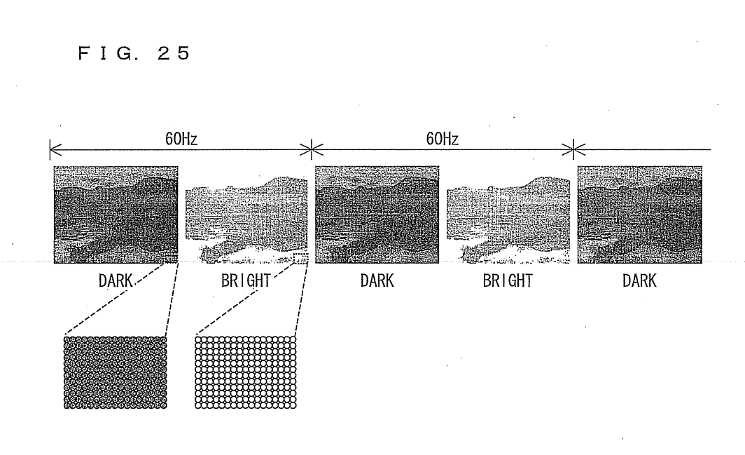

With the configuration, the luminance dividing sub-frame display is carried out with respect to only display area with large luminance difference (where excess luminance is likely to appear) in the display plane of the liquid crystal panel 10. Consequently, luminance difference between sub-frames is smaller than that in a display state where the luminance dividing sub-frame display is carried out with respect to the whole display plane of the liquid crystal panel 10 (see FIG. 25). FIG. 5 is a drawing showing a display state per 120 Hz in driving of 60 Hz per one frame in the liquid crystal display device 80 in accordance with the present embodiment. As shown in FIG. 5, the luminance difference between sub-frames is smaller than that in FIG. 25, so that flickers are less likely to be observed.

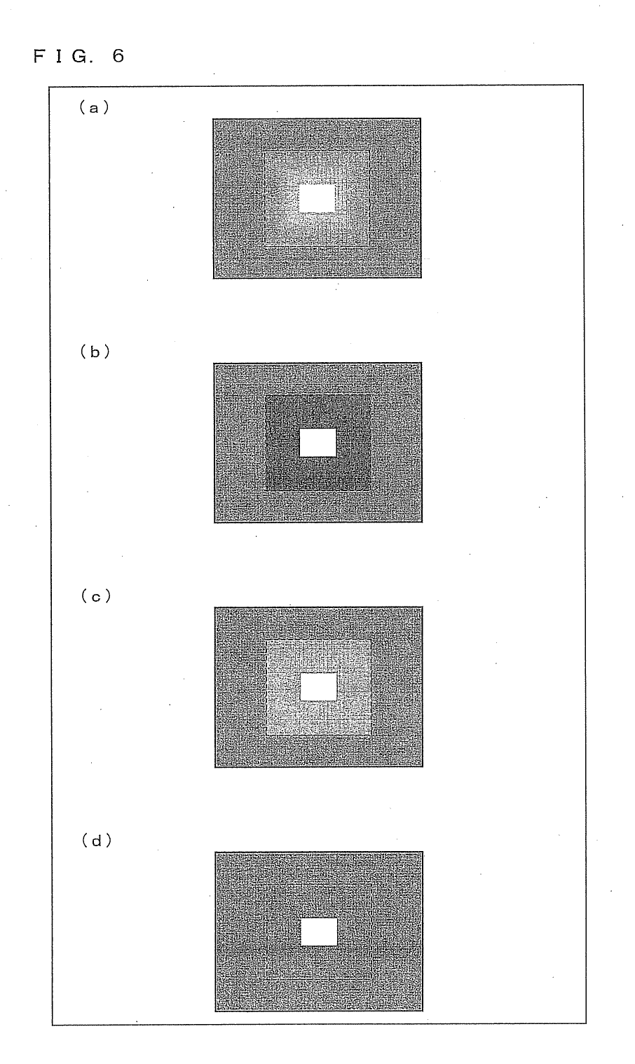

FIG. 6 is a drawing for explaining a process of partially carrying out the luminance dividing sub-frame display. (a) of FIG. 6 shows a part where excess luminance (excess brightness) is likely to appear due to large luminance difference (part surrounded by dotted lines). A state where excess luminance appears is shown for convenience of explanation. (b) of FIG. 6 shows a state in the first half of one frame (first sub-frame), of the part where excess luminance is likely to appear. The first sub-frame has a dark state derived from the first sub-frame data DSF1 with low luminance. (c) of FIG. 6 shows a state in the second half of one frame (second sub-frame) of the part where excess luminance is likely to appear. The second sub-frame has a bright state derived from the second sub-frame data DSF2 with high luminance. (d) of FIG. 6 shows a display state per one frame which is the sum total of the display in (b) and the display in (c). As shown in (d) of FIG. 6, it is possible to subdue excess luminance by partially carrying out the luminance dividing sub-frame display.

### First Example

The following explains a specific example (First Example) with reference to FIGS. 2, 7(a)-7(c), 8, 9(a), 9(b), 10(a), and 10(b).

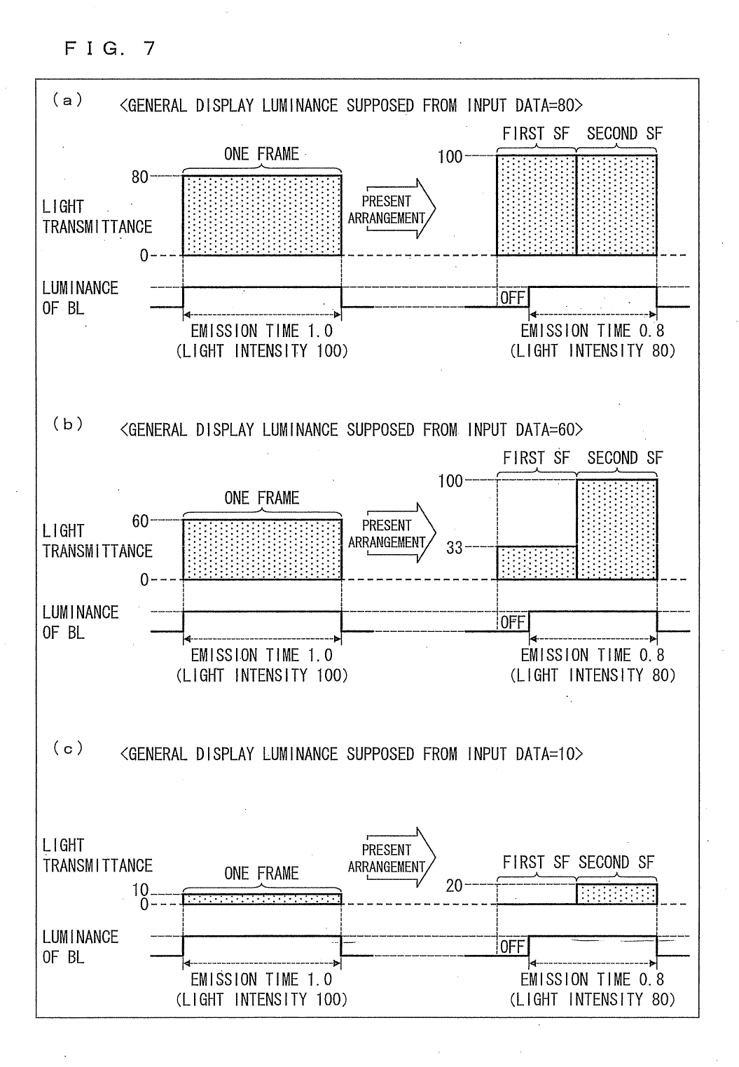

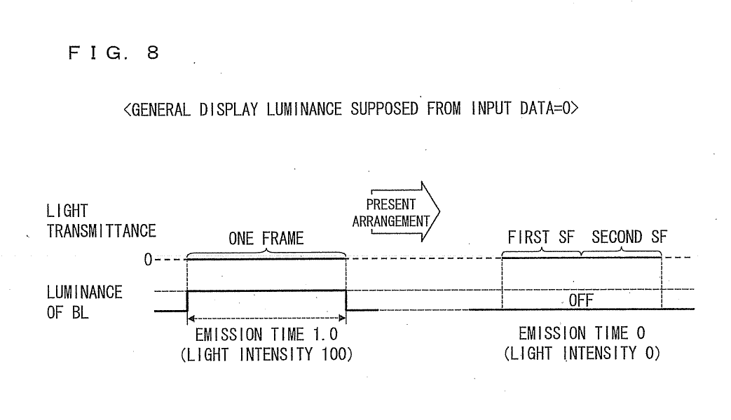

The display area HAR1 in FIG. 2 is explained below with reference to (a) to (c) of FIG. 7. Initially, the backlight control section 15 calculates display luminance of frame data DF in the display area HAR1. In the display area HAR1, it is supposed that display luminance of the moon part is 80, display luminance of the airplane's wing part is 10, and display luminance of other part (sky part) is 60. In this case, maximum display luminance is 80 and minimum display luminance is 10, so that luminance difference is 70. In a case where the threshold is set to be 15, the luminance different of 70 is larger than the threshold of 15, and accordingly the “luminance dividing sub-frame display” is carried out with respect to the display area HAR1.

Since the maximum display luminance supposed in the display area HAR1 is 80, the backlight control section 15 determines that light intensity per one frame of the illumination area LAR1 is 80. That is, the backlight control section 15 determines that the period of emission of the illumination area LAR1 is 0.8 frame, emission is not made during 0.2 frame from the start of the frame, and emission is made during the remaining 0.8 frame.

The sub-frame data generating section 22 generates sub-frame data (DSF1 and DSF2) in accordance with the result of determination (luminance difference of 70>threshold of 15) by the display luminance determining section 16. That is, the sub-frame data generating section 22 generates the first sub-frame data DSF1 and the second sub-frame data DSF2 in accordance with setting (light intensity of 80) by the backlight control section 15 and the frame data DF. This is schematically shown in (a) to (c) of FIG. 7.

As shown in (a) of FIG. 7, with respect to the moon part (part with supposed display luminance of 80) in the display area HAR1, the sub-frame data generating section 22 generates first sub-frame data DSF1 indicative of light transmittance of 100% and second sub-frame data DSF2 indicative of light transmittance of 100%. During 0.2 frame from the start of the frame, since emission from the illumination area LAR1 is not made, display luminance is 0 even when the light transmittance of the display area HAR1 is set to 100%. Further, during the remaining 0.8 frame, since emission from the illumination area LAR1 is made, the display luminance is 100 when the light transmittance of the display area HAR1 is 100%. This is schematically shown in (a) of FIG. 7 which is a configuration of the present invention, which shows that sub-frame display can be made while reducing light intensity of the illumination area LAR1.

Further, as shown in (b) of FIG. 7, with respect to the sky part (part with supposed display luminance of 60) in the display area HAR1, the sub-frame data generating section 22 generates first sub-frame data DSF1 indicative of light transmittance of 33% and second sub-frame data DSF2 indicative of light transmittance of 100%. During 0.2 frame from the start of the frame, since emission from the illumination area LAR1 is not made, display luminance is 0 even when the light transmittance of the display area HAR1 is set to 33%. Further, during the remaining 0.8 frame, since emission from the illumination area LAR1 is made, the display luminance is 33 when the light transmittance of the display area HAR1 is 33%, and the display luminance is 100 when the light transmittance of the display area HAR1 is 100%. This is schematically shown in (b) of FIG. 7 which is a configuration of the present invention, which shows that sub-frame display can be made while reducing light intensity of the illumination area LAR1.

Further, as shown in (c) of FIG. 7, with respect to the wing part (part with supposed display luminance of 10) in the display area HAR1, the sub-frame data generating section 22 generates first sub-frame data DSF1 indicative of light transmittance of 0% and second sub-frame data DSF2 indicative of light transmittance of 20%. During 0.2 frame from the start of the frame, since emission from the illumination area LAR1 is not made (and light transmittance of the display area HAR1 is 0%), display luminance is 0. Further, during the remaining 0.8 frame, since emission from the illumination area LAR1 is made, the display luminance is 0 when the light transmittance of the display area HAR1 is 0%, and the display luminance is 20 when the light transmittance of the display area HAR1 is 20%. This is schematically shown in (c) of FIG. 7 which is a configuration of the present invention, which shows that sub-frame display can be made while reducing light intensity of the illumination area LAR1. In addition, in the first sub-frame, since emission from the illumination area LAR1 is not made during the first half (0.2 frame), the display luminance can be surely 0 without leakage of light etc.

The following explains the display area HAR2 in FIG. 2. Black display is made in the display area HAR2, and supposed maximum display luminance is 0.

Since the maximum display luminance supposed in the display area HAR2 is 0, the backlight control section 15 determines that light intensity per one frame of the illumination area LAR2 is 0. That is, the backlight control section 15 determines that emission is not made throughout the frame.

The sub-frame data generating section 22 generates first sub-frame data DSF1 and second sub-frame data DSF2 in accordance with setting (light intensity of 0) by the backlight control section 15 and frame data DF in the display area HAR2. This is schematically shown in FIG. 8.

As shown in FIG. 8, with respect to the display area HAR2 (part with supposed display luminance of 0), the sub-frame data generating section 22 generates first sub-frame data DSF1 indicative of light transmittance of 0% and second sub-frame data DSF2 indicative of light transmittance of 0%. This is schematically shown in FIG. 8 which is a configuration of the present invention, which shows that sub-frame display can be carried out while making light intensity of the illumination area LAR2 zero.

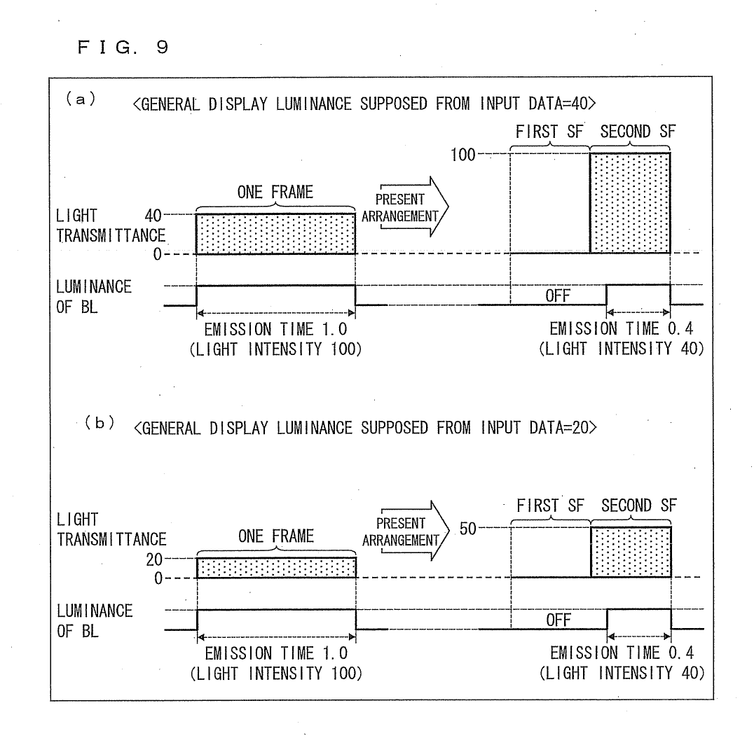

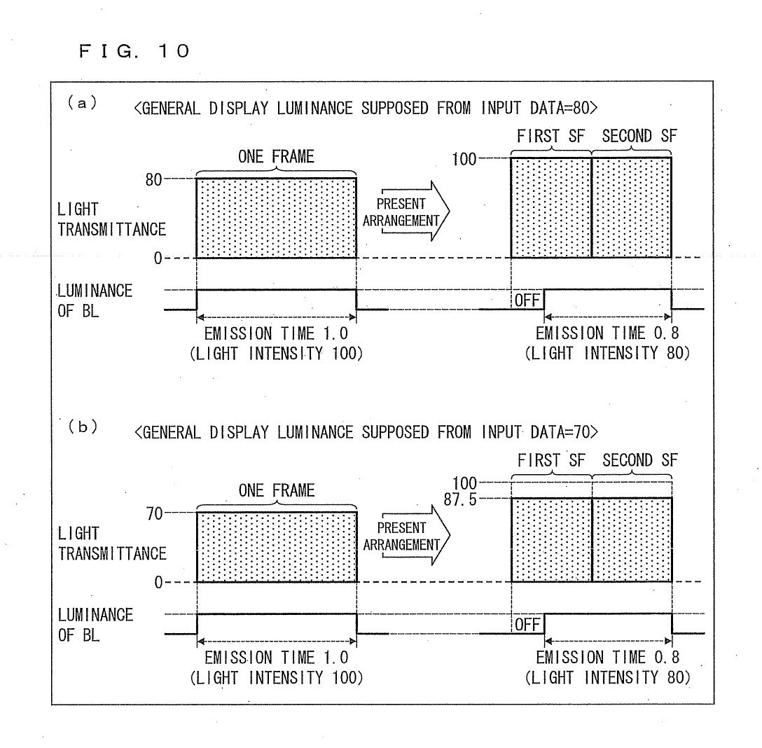

The following explains the display area HAR3 in FIG. 2 with reference to (a) of FIG. 9 and (b) of FIG. 9. In the display area HAR3, it is supposed that display luminance of the background of the tree is 40, and display luminance of the tree is 20. In this case, maximum display luminance is 40 and minimum display luminance is 20 so that luminance difference is 20. In a case where the threshold is 15, the luminance difference of 20 is larger than the threshold of 15, so that the “luminance dividing sub-frame display” is carried out with respect to the display area HAR3.

Since the maximum display luminance supposed in the display area HAR3 is 40, the backlight control section 15 determines that light intensity per one frame of the illumination area LAR3 is 40. That is, the backlight control section 15 determines that the period of emission of the illumination area LAR3 is 0.4 frame, emission is not made during 0.6 frame from the start of the frame, and emission is made during the remaining 0.4 frame.

The sub-frame data generating section 22 generates sub-frame data (DSF1 and DSF2) in accordance with the result of determination (luminance difference of 20>threshold of 15) by the display luminance determining section 16. That is, the sub-frame data generating section 22 generates the first sub-frame data DSF1 and the second sub-frame data DSF2 in accordance with setting (light intensity of 40) by the backlight control section 15 and the frame data DF. This is schematically shown in (a) of FIG. 9 and (b) of FIG. 9.

As shown in (a) of FIG. 9, with respect to the background of the tree part (part with supposed display luminance of 40) in the display area HAR3, the sub-frame data generating section 22 generates first sub-frame data DSF1 indicative of light transmittance of 0% and second sub-frame data DSF2 indicative of light transmittance of 100%. During 0.6 frame from the start of the frame, since emission from the illumination area LAR3 is not made (and light transmittance of the display area HAR3 is 0%), display luminance is 0. Further, during the remaining 0.4 frame, since emission from the illumination area LAR3 is made, the display luminance is 100 when the light transmittance of the display area HAR3 is 100%. This is schematically shown in (a) of FIG. 9 which is a configuration of the present invention, which shows that sub-frame display can be made while reducing light intensity of the illumination area LAR3. In addition, in the first sub-frame, since emission from the illumination area LAR3 is not made, the display luminance can be surely 0 without leakage of light etc.

Further, as shown in (b) of FIG. 9, with respect to the tree part (part with supposed display luminance of 20) in the display area HAR3, the sub-frame data generating section 22 generates first sub-frame data DSF1 indicative of light transmittance of 0% and second sub-frame data DSF2 indicative of light transmittance of 50%. During 0.6 frame from the start of the frame, since emission from the illumination area LAR3 is not made (and light transmittance of the display area HAR3 is 0), display luminance is 0. Further, during the remaining 0.4 frame, since emission from the illumination area LAR3 is made, the display luminance is 50 when the light transmittance of the display area HAR3 is 50%. This is schematically shown in (b) of FIG. 9 which is a configuration of the present invention, which shows that sub-frame display can be made while reducing light intensity of the illumination area LAR3. In addition, in the first sub-frame, since emission from the illumination area LAR3 is not made, the display luminance can be surely 0 without leakage of light etc.

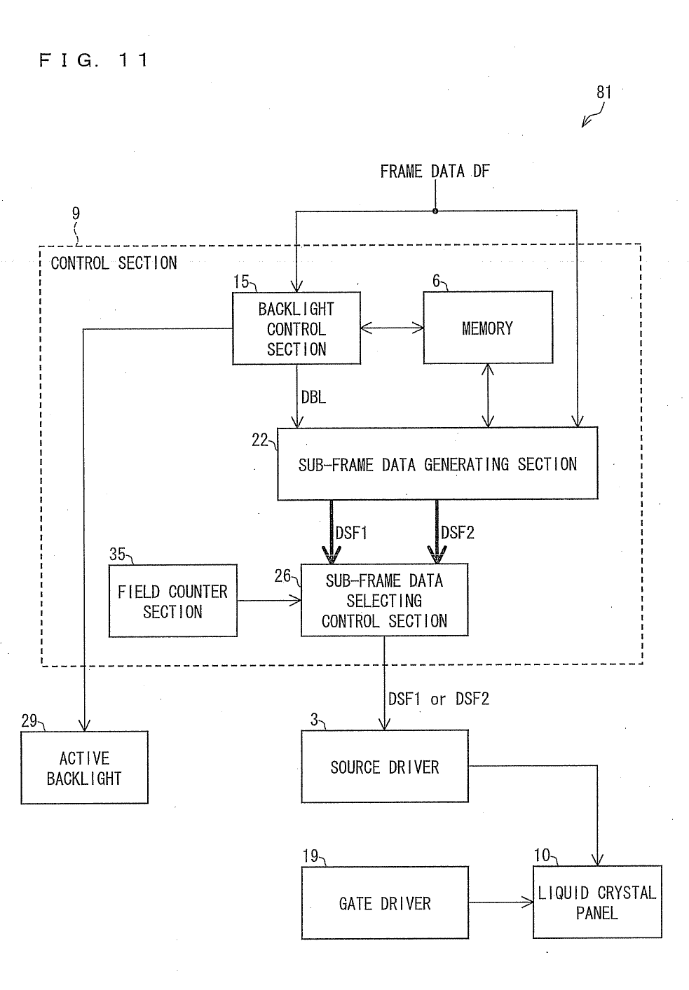

The following explains the display area HAR4 in FIG. 2 with reference to (a) of FIG. 10 and (b) of FIG. 10. In the display area HAR4, it is supposed that display luminance of the background of the house is 80 and display luminance of the house is 70. In this case, maximum display luminance is 80 and minimum display luminance is 70 so that luminance difference is 10. In a case where the threshold is 15, the luminance difference of 10 is not larger than the threshold of 15, so that the “luminance equalizing sub-frame display” is carried out with respect to the display area HAR4.

Since the maximum display luminance, supposed in the display area HAR4 is 80, the backlight control section 15 determines that light intensity per one frame of the illumination area LAR4 is 80. That is, the backlight control section 15 determines that the period of emission of the illumination area LAR4 is 0.8 frame, emission is not made during 0.2 frame from the start of the frame, and emission is made during the remaining 0.8 frame.

The sub-frame data generating section 22 generates sub-frame data (DSF1 and DSF2) in accordance with the result of determination (luminance difference of 10.5≦threshold of 15) by the display luminance determining section 16. That is, the sub-frame data generating section 22 generates the first sub-frame data DSF1 and the second sub-frame data DSF2 in accordance with setting (light intensity of 80) by the backlight control section 15 and the frame data DF. This is schematically shown in (a) of FIG. 10 and (b) of FIG. 10.

As shown in (a) of FIG. 10, with respect to the background part of the house (part with supposed display luminance of 80) in the display area HAR4, the sub-frame data generating section 22 generates first sub-frame data DSF1 indicative of light transmittance of 100% and second sub-frame data DSF2 indicative of light transmittance of 100%. During 0.2 frame from the start of the frame, since emission from the illumination area LAR4 is not made, display luminance is 0 even when the light transmittance of the display area HAR4 is set to 100%. Further, during the remaining 0.8 frame, since emission from the illumination area LAR4 is made, the display luminance is 100 when the light transmittance of the display area HAR4 is 100%. This is schematically shown in (a) of FIG. 10 which is a configuration of the present invention, which shows that sub-frame display can be made while reducing light intensity of the illumination area LAR4.

Further, as shown in (b) of FIG. 10, with respect to the house part (part with supposed display luminance of 70) in the display area HAR4, the sub-frame data generating section 22 generates first sub-frame data DSF1 indicative of light transmittance of 87.5% and second sub-frame data DSF2 indicative of light transmittance of 87.5%. During 0.2 frame from the start of the frame, since emission from the illumination area LAR4 is not made, display luminance is 0 even when the light transmittance of the display area HAR4 is set to 87.5%. Further, during the remaining 0.8 frame, since emission from the illumination area LAR4 is made, the display luminance is 87.5 when the light transmittance of the display area HAR4 is 87.5%. This is schematically shown in (b) of FIG. 10 which is a configuration of the present invention, which shows that sub-frame display can be made while reducing light intensity of the illumination area LAR4.

Here, an example of how to set light intensity of an illumination area and individual sub-frame data (DSF1 and DSf2) when carrying out the “luminance dividing sub-frame display” in First Example of the present invention. It is assumed that maximum light intensity of each illumination area is 100.

When maximum display luminance Rmax supposed in a display area HARn is not more than 50, light intensity of a corresponding illumination area is set to Rmax, and first sub-frame data DSF1 indicative of light transmittance of 0% and second sub-frame data DSF2 indicative of light transmittance of X % (X=display luminance supposed from input data÷RmaxΔ100) with respect to each input data. When the light intensity is Rmax, emission from an illumination area LARn is not made (for a continuous period of time) during (100−Rmax)÷100 frame from the start of one frame, and emission from the illumination area LARn is made (for a continuous period of time) during the remaining Rmax÷ 100 frame.

For example, when the maximum display luminance supposed in the display area HARn is 40 and the display luminance supposed from each input data is 20, light intensity of the area LARn is set to 40 and first sub-frame data DSF1 indicative of light transmittance of 0% and second sub-frame data DSF2 indicative of light transmittance of 50 (=20÷40×100) % are generated. Further, since the light intensity is 40, emission from the illumination area LARn is not made (for a continuous period of time) during 0.6 frame (=(100−40)÷100) from the start of one frame, and emission from the illumination area LARn is made (for a continuous period of time) during the remaining 0.4 frame (=40÷100).

On the other hand, when the maximum display luminance Rmax supposed in the display area HARn is larger than 50, light intensity of the corresponding illumination area is set, to Rmax, and when display luminance supposed from input data is not larger than 50, first sub-frame data DSF1 indicative of light transmittance of 0% and second sub-frame data DSF2 indicative of light transmittance of X % (X=display luminance supposed from input data÷50×100) are generated. When the light intensity is Rmax, emission from the illumination area LARn is not made (for a continuous period of time) during (100−Rmax)÷100 frame from the start of one frame, and emission from the illumination area LARn is made (for a continuous period of time) during the remaining Rmax÷100 frame.

For example, when the maximum display luminance supposed in the display area HARn is 80 and the display luminance supposed from input data is 10, light intensity of the area LARn is set to 80 and first sub-frame data DSF1 indicative of light transmittance of 0% and second sub-frame data DSF2 indicative of light transmittance of 20 (=10÷50×100) % are generated. Further, since the light intensity is 80, emission from the illumination area LARn is not made (for a continuous period of time) during 0.2 frame (=(100−80)÷100) from the start of one frame, and emission from the illumination area LARn is made (for a continuous period of time) during the remaining 0.8 frame (=80÷100).

Further, when the maximum display luminance Rmax supposed in the display area HARn is larger than 50 and when display luminance supposed from input data is larger than 50, first sub-frame data DSF1 indicative of light transmittance of X % (X=(display luminance supposed from input data−50) (Rmax−50)×100) and second sub-frame data DSF2 indicative of light transmittance of 100% are generated.

For example, when the maximum display luminance supposed in the display area HARn is 80 and the display luminance supposed from input data is 60, light intensity of the illumination area LARn is set to 80 and first sub-frame data DSF1 indicative of light transmittance of 33 (=(60−50)÷(80−50)×100) % and second sub-frame data DSF2 indicative of light transmittance of 100% are generated. Further, since the light intensity is 80, emission from the illumination area LARn is not made (for a continuous period of time) during 0.2 frame from the start of one frame, and emission from the illumination area LARn is made (for a continuous period of time) during the remaining 0.8 frame.

### Second Example

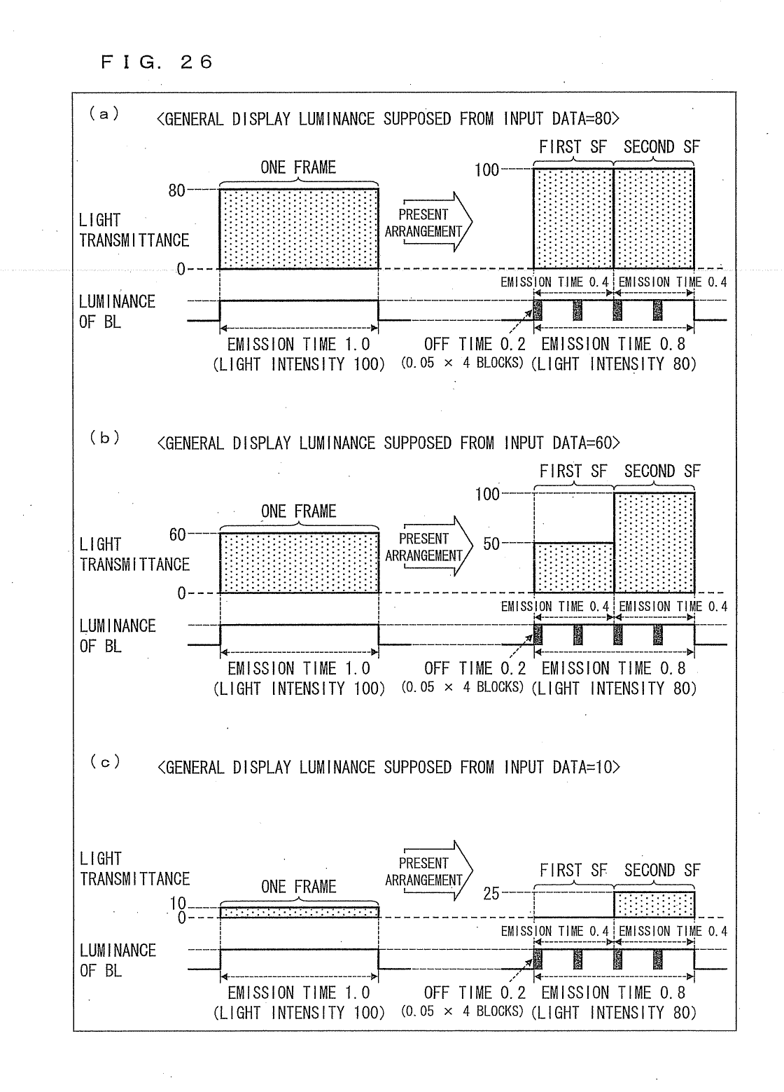

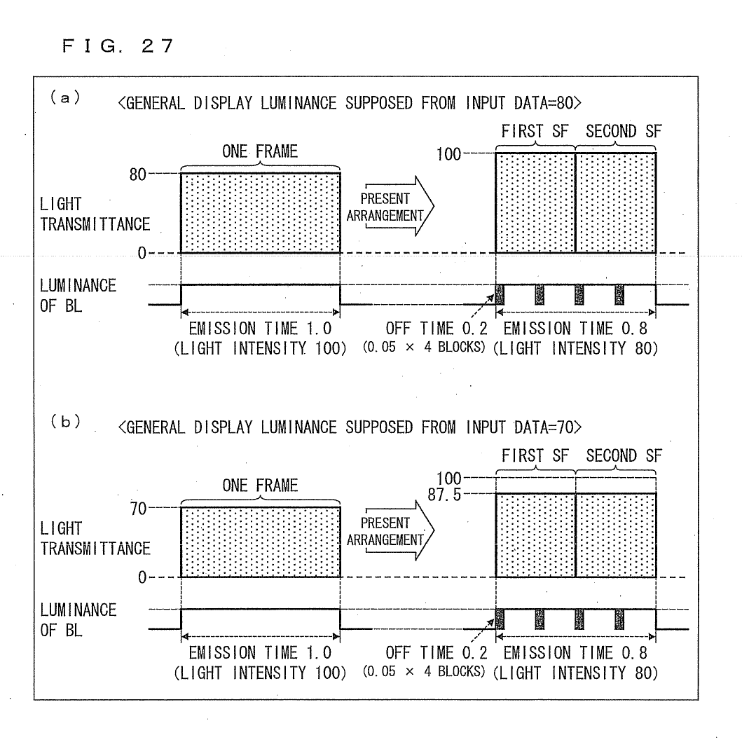

The following explains another example (Second Example) with reference to FIGS. 2, (a)-(c) of FIG. 26 and (a) and (b) of FIG. 27. For convenience of explanation, Second Example will be explained in comparison with the configurations of FIGS. 7 and 10 of First Example. In First Example, an emission time is assigned to the second half of the frame (second sub-frame), i.e. the emission time (0.8 frame in FIG. 7) of the illumination area LAR1 is set in such a manner that the illumination area LAR1 is in a non-emission state for 0.2 frame from the start of the frame and in an emission state for the remaining 0.8 frame. In contrast thereto, in Second Example, display is made while the emission time (0.8 frame) of the illumination area LAR1 is evenly assigned in one frame.

The following explains the display area HAR1 in FIG. 2 with reference to (a) of FIG. 26 to (c) of FIG. 26. Initially, the backlight control section 15 calculates display luminance of frame data DF in the display area HAR1. In the display area HAR1, it is supposed that display luminance of the moon part is 80, display luminance of the airplane's wing part is 10, and display luminance of other part (sky part) is 60. In this case, maximum display luminance is 80 and minimum display luminance is 10, so that luminance difference is 70. In a case where the threshold is set to be 15, the luminance difference of 70 is larger than the threshold of 15, and accordingly the “luminance dividing sub-frame display” is carried out with respect to the display area HAR1.

Since the maximum display luminance supposed in the display area HAR1 is 80, the backlight control section 15 determines that light intensity per one frame of the illumination area LAR1 is 80. That is, the backlight control section 15 evenly assigns an emission time of the illumination area LAR1 in one frame. For example, emission is not made during 0.05 frame from the start of one frame, emission is made during the next 0.2 frame, and this is repeated during the remaining frame. Consequently, one frame as a whole includes 4 blocks of a non-emission period of 0.05 frame and 4 blocks of an emission period of 0.2 frame, so that a non-emission state sums to 0.2 frame and an emission state sums to remaining 0.8 frame. Further, each sub-frame has 2 blocks of a non-emission period of 0.05 frame and 2 blocks of an emission period of 0.2 frame, so that each sub-frame has an equal emission period of 0.4 frame.

The sub-frame data generating section 22 generates sub-frame data (DSF1 and DSF2) in accordance with the result of determination (luminance difference of 70>threshold of 15) by the display luminance determining section 16. That is, the sub-frame data generating section 22 generates the first sub-frame data DSF1 and the second sub-frame data DSF2 in accordance with setting (light intensity of 80) by the backlight control section 15 and the frame data DF. This is schematically shown in (a) of FIG. 26 to (c) of FIG. 26.

As shown in (a) of FIG. 26, with respect to the moon part (part with supposed display luminance of 80) in the display area HAR1, the sub-frame data generating section 22 generates first sub-frame data DSF1 indicative of light transmittance of 100% and second sub-frame data DSF2 indicative of light transmittance of 100%. During 0.05 frame from the start of the frame, since emission from the illumination area LAR1 is not made, display luminance is 0 even when the light transmittance of the display area HAR1 is set to 100%. During the next 0.2 frame, since emission from the illumination area LAR1 is made, the display luminance is 100 when the light transmittance of the display area HAR1 is 100%. During the next 0.05 frame, since emission from the illumination area LAR1 is not made, the display luminance is 0. During the next 0.2 frame, since emission from the illumination area LAR1 is made, the display luminance is 100.

Similarly, in the second sub-frame, during 0.05 frame from the start of the second sub-frame (after 0.5 frame from the start of the frame), since emission from the illumination area LAR1 is not made, display luminance is 0 even when the light transmittance of the display area HAR1 is set to 100%. During the next 0.2 frame, since emission from the illumination area LAR1 is made, the display luminance is 100 when the light transmittance of the display area HAR1 is 100%. During the next 0.05 frame, since emission from the illumination area LAR1 is not made, the display luminance is 0. During the next 0.2 frame, since emission from the illumination area LAR1 is made, the display luminance is 100. This is schematically shown in (a) of FIG. 26 which is a configuration of the present invention, which shows that sub-frame display can be made while reducing light intensity of the illumination area LAR1.

Further, as shown in (b) of FIG. 26, with respect to the sky part (part with supposed display luminance of 60) in the display area HAR1, the sub-frame data generating section 22 generates first sub-frame data DSF1 indicative of light transmittance of 50% and second sub-frame data DSF2 indicative of light transmittance of 100%. During 0.05 frame from the start of the frame, since emission from the illumination area LAR1 is not made, display luminance is 0 even when the light transmittance of the display area HAR1 is set to 50%. During the next 0.2 frame, since emission from the illumination area LAR1 is made, the display luminance is 50 when the light transmittance of the display area HAR1 is 50%. During the next 0.05 frame, since emission from the illumination area LAR1 is not made, the display luminance is 0. During the next 0.2 frame, since emission from the illumination area LAR1 is made, the display luminance is 50.

In the second sub-frame, during 0.05 frame from the start of the second sub-frame (after 0.5 frame from the start of the frame), since emission from the illumination area LAR1 is not made, display luminance is 0 even when the light transmittance of the display area HAR1 is set to 100%. During the next 0.2 frame, since emission from the illumination area LAR1 is made, the display luminance is 100 when the light transmittance of the display area HAR1 is 100%. During the next 0.05 frame, since emission from the illumination area LAR1 is not made, the display luminance is 0. During the next 0.2 frame, since emission from the illumination area LAR1 is made, the display luminance is 100. This is schematically shown in (b) of FIG. 26 which is a configuration of the present invention, which shows that sub-frame display can be made while reducing light intensity of the illumination area LAR1.

Further, as shown in (c) of FIG. 26, with respect to the wing part (part with supposed display luminance of 10) in the display area HAR1, the sub-frame data generating section 22 generates first sub-frame data DSF1 indicative of light transmittance of 0% and second sub-frame data DSF2 indicative of light transmittance of 25%. During 0.05 frame from the start of the frame, since emission from the illumination area LAR1 is not made (and light transmittance of the display area HAR1 is 0%), display luminance is 0. During the next 0.2 frame, since emission from the illumination area LAR1 is made, the display luminance is 0 when the light transmittance of the display area HAR1 is 0%. During the next 0.05 frame, since emission from the illumination area LAR1 is not made, the display luminance is 0. During the next 0.2 frame, although emission from the illumination area LAR1 is made, the display luminance is 0.

In the second sub-frame, during 0.05 frame from the start of the second sub-frame (after 0.5 frame from the start of the frame), since emission from the illumination area LAR1 is not made, display luminance is 0 even when the light transmittance of the display area HAR1 is set to 25%. During the next 0.2 frame, since emission from the illumination area LAR1 is made, the display luminance is 25 when the light transmittance of the display area HAR1 is 25%. During the next 0.05 frame, since emission from the illumination area LAR1 is not made, the display luminance is 0. During the next 0.2 frame, since emission from the illumination area LAR1 is made, the display luminance is 25. This is schematically shown in (c) of FIG. 26 which is a configuration of the present invention, which shows that sub-frame display can be made while reducing light intensity of the illumination area LAR1.

The “luminance dividing sub-frame display” can be carried out with respect to other display areas similarly with above.

In the display area HAR4 in FIG. 2, the luminance difference of 10 is not larger than the threshold of 15, and accordingly the “luminance equalizing sub-frame display” is carried out similarly with First Example. The following explains the “luminance equalizing sub-frame display” in Second Example with reference to (a) of FIG. 27 and (b) of FIG. 27.

Since the maximum display luminance supposed in the display area HAR4 is 80, the backlight control section 15 determines that light intensity per one frame of the illumination area LAR4 is 80. That is, the backlight control section 15 evenly assigns an emission time of the illumination area LAR4 in one frame. For example, emission is not made during 0.05 frame from the start of one frame, emission is made during the next 0.2 frame, and this is repeated during the remaining frame. Consequently, one frame as a whole includes 4 blocks of a non-emission period of 0.05 frame and 4 blocks of an emission period of 0.2 frame, so that a non-emission state sums to 0.2 frame and an emission state sums to remaining 0.8 frame. Further, each sub-frame has 2 blocks of a non-emission period of 0.05 frame and 2 blocks of an emission period of 0.2 frame, so that each sub-frame has an equal emission period of 0.4 frame.

The sub-frame data generating section 22 generates sub-frame data (DSF1 and DSF2) in accordance with the result of determination (luminance difference of 10≦threshold of 15) by the display luminance determining section 16. That is, the sub-frame data generating section 22 generates the first sub-frame data DSF1 and the second sub-frame data DSF2 in accordance with setting (light intensity of 80) by the backlight control section 15 and the frame data DF. This is schematically shown in (a) of FIG. 27 and (b) of FIG. 27.

As shown in (a) of FIG. 27, with respect to the background part of the house (part with supposed display luminance of 80) in the display area HAR4, the sub-frame data generating section 22 generates first sub-frame data DSF1 indicative of light transmittance of 100% and second sub-frame data DSF2 indicative of light transmittance of 100%. During 0.05 frame from the start of the frame, since emission from the illumination area LAR4 is not made, display luminance is 0 even when the light transmittance of the display area HAR4 is set to 100%. During the next 0.2 frame, since emission from the illumination area LAR4 is made, the display luminance is 100 when the light transmittance of the display area HAR4 is 100%. During the next 0.05 frame, since emission from the illumination area LAR4 is not made, the display luminance is 0. During the next 0.2 frame, since emission from the illumination area LAR4 is made, the display luminance is 100.

Similarly, in the second sub-frame, during 0.05 frame from the start of the second sub-frame (after 0.5 frame from the start of the frame), since emission from the illumination area LAR4 is not made, display luminance is 0 even when the light transmittance of the display area HAR4 is set to 100%. During the next 0.2 frame, since emission from the illumination area LAR4 is made, the display luminance is 100 when the light transmittance of the display area HAR4 is 100%. During the next 0.05 frame, since emission from the illumination area LAR4 is not made, the display luminance is 0. During the next 0.2 frame, since emission from the illumination area LAR4 is made, the display luminance is 100. This is schematically shown in (a) of FIG. 27 which is a configuration of the present invention, which shows that sub-frame display can be made while reducing light intensity of the illumination area LAR4.

Further, as shown in (b) of FIG. 27, with respect to the house part (part with supposed display luminance of 70) in the display area HAR4, the sub-frame data generating section 22 generates first sub-frame data DSF1 indicative of light transmittance of 87.5% and second sub-frame data DSF2 indicative of light transmittance of 87.5%. During 0.05 frame from the start of the frame, since emission from the illumination area LAR4 is not made, display luminance is 0 even when the light transmittance of the display area HAR4 is set to 87.5%. During the next 0.2 frame, since emission from the illumination area LAR4 is made, the display luminance is 87.5 when the light transmittance of the display area HAR4 is 87.5%. During the next 0.05 frame, since emission from the illumination area LAR4 is not made, the display luminance is 0. During the next 0.2 frame, since emission from the illumination area LAR4 is made, the display luminance is 87.5.

Similarly, in the second sub-frame, during 0.05 frame from the start of the second sub-frame (after 0.5 frame from the start of the frame), since emission from the illumination area LAR4 is not made, display luminance is 0 even when the light transmittance of the display area HAR4 is set to 87.5%. During the next 0.2 frame, since emission from the illumination area LAR4 is made, the display luminance is 87.5 when the light transmittance of the display area HAR4 is 87.5%. During the next 0.05 frame, since emission from the illumination area LAR4 is not made, the display luminance is 0. During the next 0.2 frame, since emission from the illumination area LAR4 is made, display luminance is 87.5. This is schematically shown in (b) of FIG. 27 which is a configuration of the present invention, which shows that sub-frame display can be made while reducing light intensity of the illumination area LAR4.

The following explains an example of how to set light intensity of an illumination area and individual sub-frame data (DSF1 and DSf2) when carrying out the “luminance dividing sub-frame display” in Second Example of the present invention. It is assumed that maximum light intensity of each illumination area is 100.

In a case where the maximum display luminance supposed in the display area HARn is Rmax, when display luminance supposed from input data≧(Rmax÷2), first sub-frame data DSF1 indicative of light transmittance X (X=(display luminance supposed from input data−(Rmax+2))+(Rmax÷2)×100) and second sub-frame data DSF2 indicative of light transmittance of 100% are generated. When the light intensity is Rmax, emission from the illumination area LARn is not made during (100−Rmax)÷100 frame and emission from the illumination area LARn is made during the remaining Rmax÷100 frame. The period for a non-emission state and the period for an emission state are evenly assigned in one frame.

For example, in a case where the maximum display luminance supposed in the display area HARn is 80 and display luminance supposed from input data is 60%, light intensity of the illumination area LARn is set to 80, and first sub-frame data DSF1 indicative of light transmittance 50 (=(60−(80÷2))÷(80÷2)×100) % and second sub-frame data DSF2 indicative of light transmittance of 100% are generated. Since the light intensity is 80, emission from the illumination area LARn is not made during 0.2 frame (=(100−80)÷100) frame and emission from the illumination area LARn is made during the remaining 0.8 (=80÷100) frame. For example, emission is not made during 0.05 frame from the start of one frame and emission is made during the next 0.2 frame. Thereafter, this is repeated (see (b) of FIG. 26).

On the other hand, in a case where the maximum display luminance supposed in the display area HARn is Rmax, when display luminance supposed from input data<(Rmax÷2), light intensity of a corresponding illumination area is set to Rmax and first sub-frame data DSF1 indicative of light transmittance of 0 and second sub-frame data DSF2 indicative of light transmittance of X (X=(display luminance supposed from input data÷(Rmax÷2))×100) are generated with respect to each input data.

For example, in a case where the maximum display luminance supposed in the display area HARn is 80 and display luminance supposed from input data is 10, light intensity of the illumination area LARn is set to 80, and first sub-frame data DSF1 indicative of light transmittance of 0% and second sub-frame data DSF2 indicative of light transmittance of 25 (=10÷(80÷2)×100) % are generated. Since the light intensity is 80, emission from the illumination area LARn is not made during 0.2 (=(100−80)÷100) frame and emission from the illumination area LARn is made during the remaining 0.8 (=80÷100) frame. For example, emission is not made during 0.05. frame from the start of one frame and emission is made during the next 0.2 frame. Thereafter, this is repeated (see (c) of FIG. 26).

The liquid crystal display device in accordance with the present embodiment may be arranged as follows.

Explanations were made above as to a case where the first sub-frame which is the first half of one frame is set to be in a non-emission state or to have low display luminance, and the second sub-frame which is the second half of one frame is set to have high display luminance. However, the present invention is not limited to this case. Alternatively, the present invention may be arranged such that the first sub-frame which is the first half of one frame is set to have high display luminance, and the second sub-frame which is the second half of one frame is set to be in a non-emission state or to have low display luminance.

When the backlight control section 15 determines light intensity per one frame of the illumination area LAR, it is desirable that the influence of crosstalk is considered. When light intensity of a backlight is changed with respect to each illumination area, light from an illumination area adjacent to a certain display area is mixed into light illuminating the certain display area due to a crosstalk between illumination areas (diffraction of illumination light from adjacent display areas). In order to deal with this problem, the backlight control section 15 temporarily calculates light intensities per one frame of individual illumination areas LAR based on maximum display luminance supposed in individual display areas HAR, and finally determines light intensities of the illumination areas LAR based on light intensities of adjacent display areas. Specifically, the temporarily calculated light intensities of individual illumination areas LAR are corrected with reference to an LUT (look-up table). The LUT stores therein light intensity correction data which corresponds to combinations of light intensities of illumination areas of interest and light intensities of adjacent illumination areas. The backlight control section 15 outputs the finally determined light intensity as data DBL to the sub-frame data generating section 22.

Alternatively, LEDs corresponding to R, G, and B respectively may be used in the area active backlight 29. In this case, light intensity per one frame of the illumination area LAR is determined with respect to each of R, G, and B based on maximum display luminance (R, G B) supposed in the display area HAR. Thereafter, the sub-frame data generating section 22 generates first sub-frame data DSF1 and second sub-frame data DSF2 based on the determined light intensities for R, G, and B and frame data DF (R, G, and B data).

### Second Embodiment

The following explains another embodiment of the liquid crystal display device of the present invention. For convenience of explanation, members having the same functions as those shown in First Embodiment are given the same reference numerals. Terms defined in First Embodiment are used with the same definitions in the present embodiment unless otherwise stated.

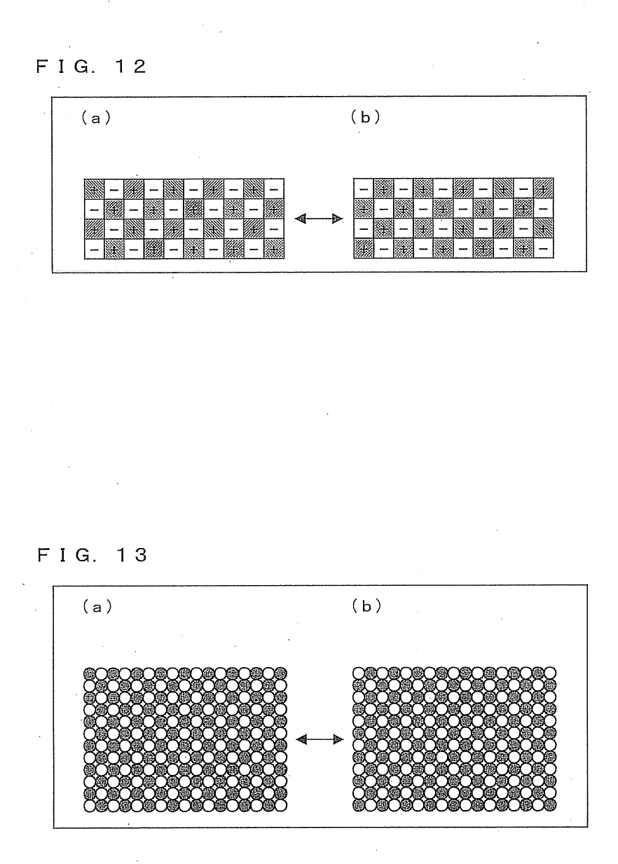

FIG. 11 is a block diagram showing a configuration of a liquid crystal display device in accordance with the present embodiment. As shown in FIG. 11, a liquid crystal display device 81 in accordance with the present embodiment includes an area active backlight (active backlight, backlight) 29, a liquid crystal panel 10, a gate driver 19, a source driver 3, and a control section 9. The liquid crystal panel 10 may be combined integrally with individual drivers (source driver 3 and gate driver 19).

As shown in FIG. 3, the area active backlight 29 includes a plurality of illumination areas LAR, and each illumination area LAR is designed such that light intensity per one frame can be controlled individually. As shown in FIG. 2, the liquid crystal panel 10 includes, in its display section, a plurality of display areas HAR respectively corresponding to illumination areas LAR of the area active backlight 29. For example, a display area HAR1 of the liquid crystal panel 10 corresponds to an illumination area LAR1 of the area active backlight 29.

The control section 9 of the liquid crystal display device 81 in accordance with the present embodiment includes a memory 6, a backlight control section 15, a sub-frame data generating section 22, a sub-frame data selecting control section 26, and a field counter section 35. To the backlight control section 15 and the sub-frame data generating section 22 is inputted frame data (input data) DF. The frame data DF is RGB data. Although not shown in the drawings, the control section 9 includes a timing control section to which a vertical sync signal, a horizontal sync signal, a dot clock etc. are inputted. The timing control section controls the backlight control section 15, the sub-frame data generating section 22, the sub-frame data selecting control section 26, the gate driver 19 etc.

The backlight control section 15 calculates maximum display luminance supposed in a display area HAR based on all frame data DF in the display area HAR, determines, based on the calculated maximum display luminance, light intensity per one frame of an illumination area LAR corresponding to the display area HAR, and outputs the light intensity as data DBL to the sub-frame data generating section 22. Further, the backlight control section 15 regulates (sets) light intensity per one frame of the illumination area LAR in accordance with the determined light intensity. In the liquid crystal display device 81 in accordance with the present embodiment, illumination luminance of the illumination area LAR is made constant, and light intensity per one frame of the illumination area LAR is regulated by changing an emission time in one frame (i.e. during what percentage of one frame emission is made).

In order to carry out the “luminance dividing sub-frame display”, the sub-frame data generating section 22 generates first sub-frame data DSF1 and second sub-frame data DSF2 in accordance with the frame data DF and the light intensity per one frame of the illumination area LAR (data DBL) determined by the backlight control section 15.

The first sub-frame data DSF1 and the second sub-frame data DSF2 which have been generated by the sub-frame data generating section 22 are inputted to the sub-frame data selecting control section 26. The sub-frame data selecting control section 26 switches the first sub-frame data DSF1 and the second sub-frame data DSF2 at double speed (e.g. 120 Hz). The field counter section 35 determines whether in a first sub-frame or a second sub-frame, and outputs the result of determination to the sub-frame data selecting control section 26.

In accordance with the result of determination by the field counter section 35, the sub-frame data selecting control section 26 outputs the first sub-frame data DSF1 to the source driver 3 at start timing of the first sub-frame, and outputs the second sub-frame data DSF2 to the source driver 3 at start timing of the second sub-frame.

The source driver 3 converts the sub-frame data (DSF1 and DSF2) into analog potential signals, and drives individual source lines (data signal lines) of the liquid crystal panel 10 using the potential signals. Further, the gate driver 19 drives gate lines (scanning signal lines) of the liquid crystal panel 10.

How the sub-frame data generating section 22 sets light intensity per one frame of the illumination area LAR and how the sub-frame data generating section 22 generates the first sub-frame data DSF1 and the second sub-frame data DSf2 are the same as those in First Embodiment and explanations thereof are omitted here. The following explains how the first sub-frame data DSF1 and the second sub-frame data DSF2 generated by the sub-frame data generating section 22 are outputted to the source driver 3, as well as a specific configuration of the sub-frame data selecting control section 26. In the following, out of the first sub-frame data DSF1 and the second sub-frame data DSF2, sub-frame data with lower display luminance is referred to as dark sub-frame data and sub-frame data with higher display luminance is referred to as bright sub-frame data.

The sub-frame data selecting control section 26 outputs the dark sub-frame data and the bright sub-frame data to the source driver 3 in such a manner that the dark sub-frame data and the bright sub-frame data are switched with each other with respect to each frame.

Specifically, during a first frame, dark sub-frame data is outputted to the source driver 3 at start timing of a first sub-frame, and bright sub-frame data is outputted to the source driver 3 at start timing of a second sub-frame. During a second frame, bright sub-frame data is outputted to the source driver 3 at start timing of a first sub-frame, and dark sub-frame data is outputted to the source driver 3 at start timing of a second sub-frame. During a third frame, dark sub-frame data is outputted to the source driver 3 at start timing of a first sub-frame, and bright sub-frame data is outputted to the source driver 3 at start timing of a second sub-frame. This process is repeated thereafter.

Further, the sub-frame data selecting control section 26 outputs, to the source driver 3, dark sub-frame data and bright sub-frame data in such a manner that the dark sub-frame data and the bright sub-frame data are positioned in a zigzag manner with respect to adjacent pixels.

Specifically, to take a first pixel and a second pixel adjacent thereto as an example, during a first frame, for the first pixel, dark sub-frame data is outputted to the source driver 3 at start timing of a first sub-frame, and bright sub-frame data is outputted to the source driver 3 at start timing of a second sub-frame. For the second pixel, bright sub-frame data is outputted to the source driver 3 at start timing of the first sub-frame, and dark sub-frame data is outputted to the source driver 3 at start timing of the second sub-frame.

As described above, the sub-frame data selecting control section 26 switches dark sub-frame data and bright sub-frame data with respect to each frame. Accordingly, during a second frame, dark sub-frame data and bright sub-frame data are outputted as follows.

During the second frame, for the first pixel, bright sub-frame data is outputted to the source driver 3 at start timing of a first sub-frame, and dark sub-frame data is outputted to the source driver 3 at start timing of a second sub-frame. For the second pixel, dark sub-frame data is outputted to the source driver 3 at start timing of the first sub-frame, and bright sub-frame data is outputted to the source driver 3 at start timing of the second sub-frame. Thereafter, for each of the first pixel and the second pixel, dark sub-frame data and bright sub-frame data are switched with respect to each frame.

FIG. 12 schematically shows how to drive pixels of the liquid crystal panel 10. (a) of FIG. 12 shows how to drive pixels in an odd frame (first frame, third frame, fifth frame, . . . ) and (b) of FIG. 12 shows how to drive pixels in an even frame (second frame, fourth frame, sixth frame, . . . ). Hatched parts in the drawings indicate pixels having high luminance in the second half of one frame (second sub-frame) (i.e. pixel to which dark sub-frame data is outputted in the first sub-frame and to which bright sub-frame data is outputted in the second sub-frame). Unhatched parts indicate pixels having high luminance in the first half of one frame (first sub-frame) (i.e. pixel to which bright sub-frame data is outputted in the first sub-frame and to which dark sub-frame data is outputted in the second sub-frame). FIG. 12 shows dot inversion driving in which adjacent pixels have different polarities. However, the present invention is not limited to the dot inversion driving.

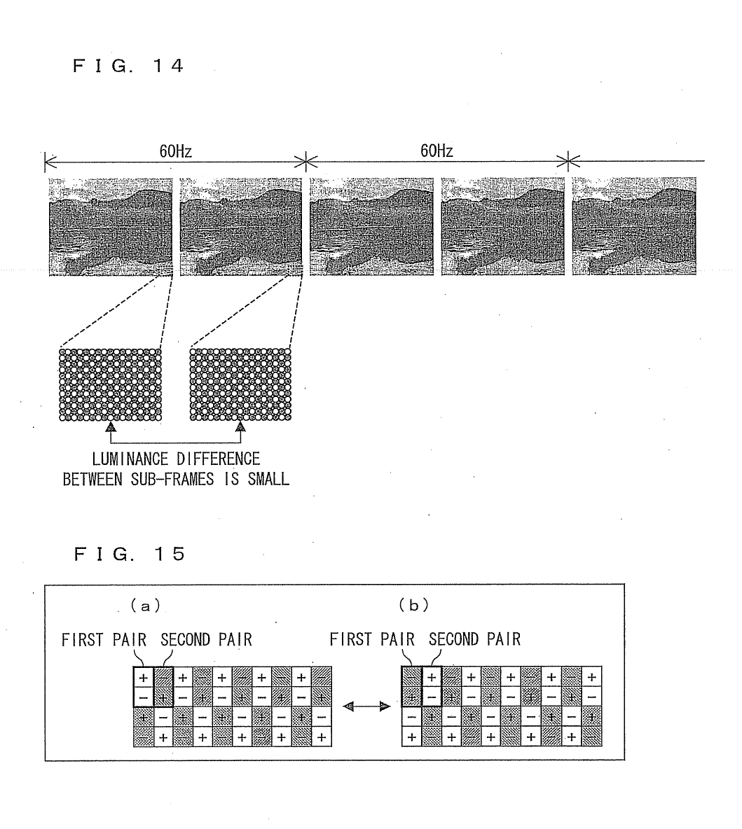

FIG. 13 is a drawing visually showing how to drive pixels in the liquid crystal panel 10 in accordance with FIG. 12. (a) of FIG. 13 shows an odd frame (first frame, third frame, fifth frame, . . . ) and (b) of FIG. 13 shows an even frame (second frame, fourth frame, sixth frame, . . . ). Black in the drawings indicates pixels having high luminance in the second half of one frame, and white indicates pixels having high luminance in the first half of one frame. As shown in FIG. 13, with the configuration, luminance difference is less likely to be seen when switching frames.

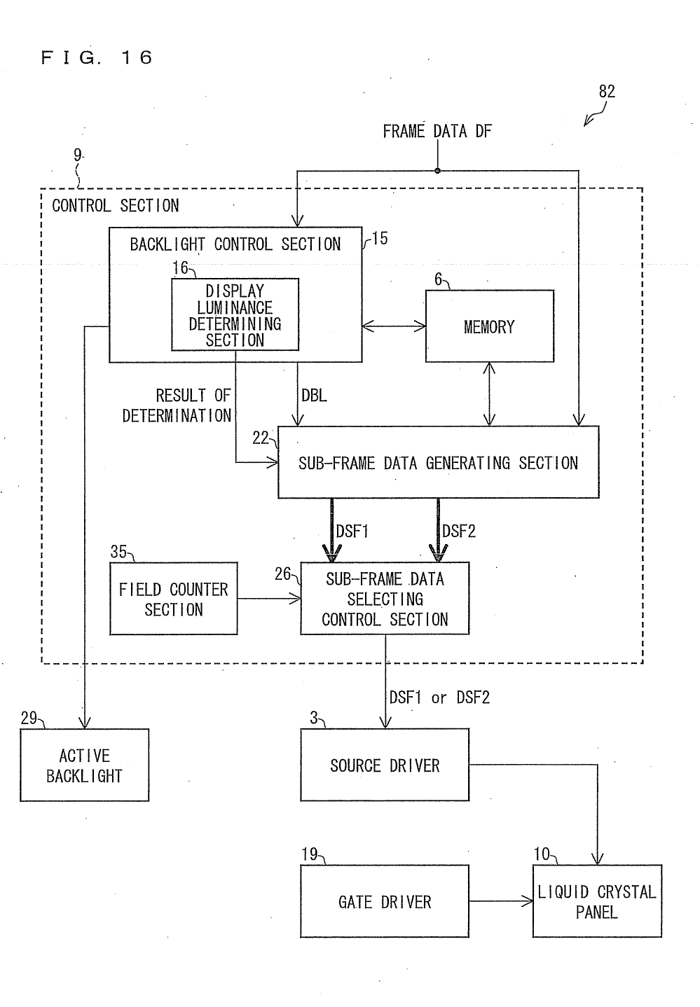

FIG. 14 is a drawing showing display states per 120 Hz (sub-frame) in driving of 60 Hz per one frame in the liquid crystal display device in accordance with the present embodiment.

As shown in these drawings, in the liquid crystal display device 81 in accordance with the present embodiment, luminance difference between sub-frames is smaller and consequently flickers are less likely to be observed than the conventional configuration (see FIG. 25).

That is, in the liquid crystal display device 81 in accordance with the present embodiment, a difference between (i) an average of display luminances (brightness and darkness) on the whole of a display plane of a display panel in the first half of a frame (display plane at the left side of each frame (60 Hz) shown in FIG. 14) and (ii) an average of display luminances (brightness and darkness) on the whole of the display plane of the display panel in the second half of the frame (display plane at the right side of each frame (60 Hz)) is smaller than that in the case of carrying out the “luminance dividing sub-frame display” on the whole of the display plane of the display panel (see FIG. 25). Consequently, luminance difference between sub-frames is less likely to be observed.

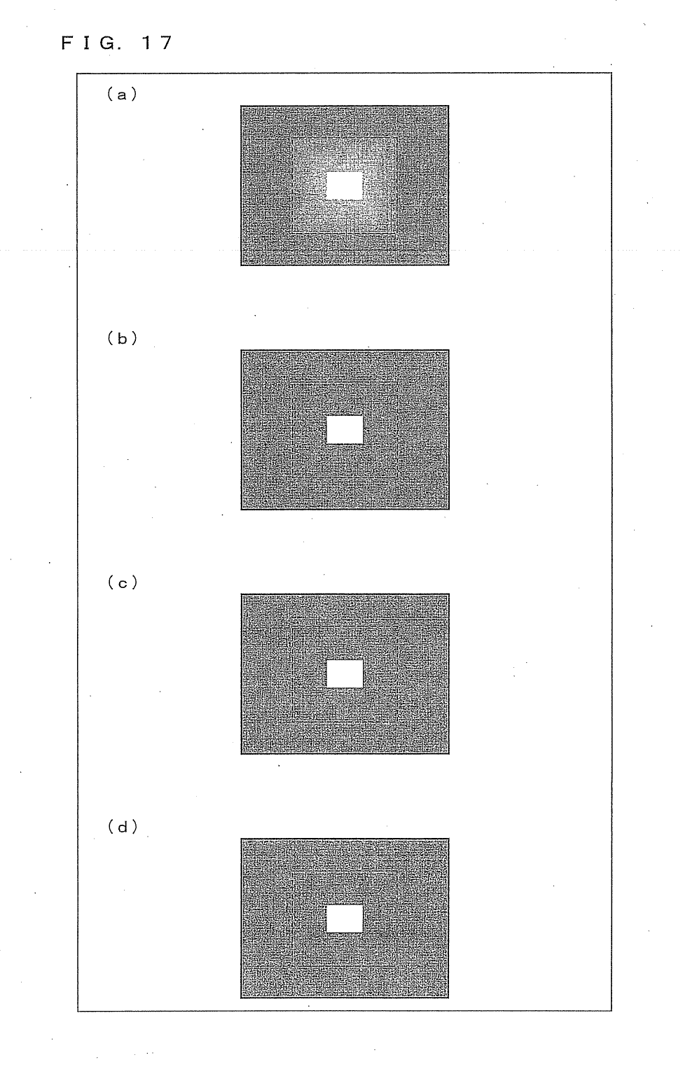

How to assign dark sub-frame data and bright sub-frame data is not limited to the configuration in FIG. 12. Alternatively, dark sub-frame data and bright sub-frame data may be switched with each other with respect to each pair of adjacent two pixels. Specifically, as shown in FIG. 15, during a first frame ((a) of FIG. 15), for a first pair of adjacent two pixels, bright sub-frame data is supplied in a first sub-frame and dark sub-frame data is supplied in a second sub-frame. For a second pair of adjacent two pixels, dark sub-frame data is supplied in the first sub-frame and bright sub-frame data is supplied in the second sub-frame. During a second frame ((b) of FIG. 15), for the first pair of adjacent two pixels, dark sub-frame data is supplied in a first sub-frame and bright sub-frame data is supplied in a second sub-frame. For the second pair of adjacent two pixels, bright sub-frame data is supplied in the first sub-frame and dark sub-frame data is supplied in the second sub-frame. Thereafter, for each pixel, dark sub-frame data and bright sub-frame data are switched with each other with respect to each frame.

### Third Embodiment

The following explains another embodiment of the liquid crystal display device of the present invention. For convenience of explanation, members having the same functions as those shown in First and Second Embodiments are given the same reference numerals. Terms defined in First and Second Embodiments are used with the same definitions in the present embodiment unless otherwise stated.

The liquid crystal display device in accordance with the present embodiment includes features of First and Second Embodiments. That is, the liquid crystal display device of the present invention is designed such that a process in which a dark sub-frame and a bright sub-frame are switched with each other with respect to each of adjacent pixels is carried out only for a display area with a large luminance difference.

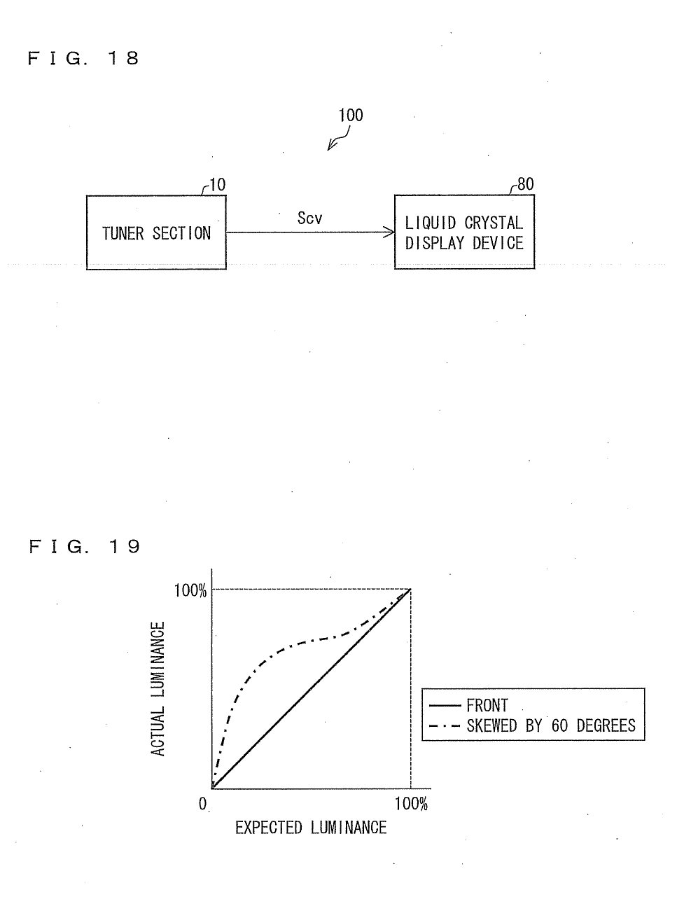

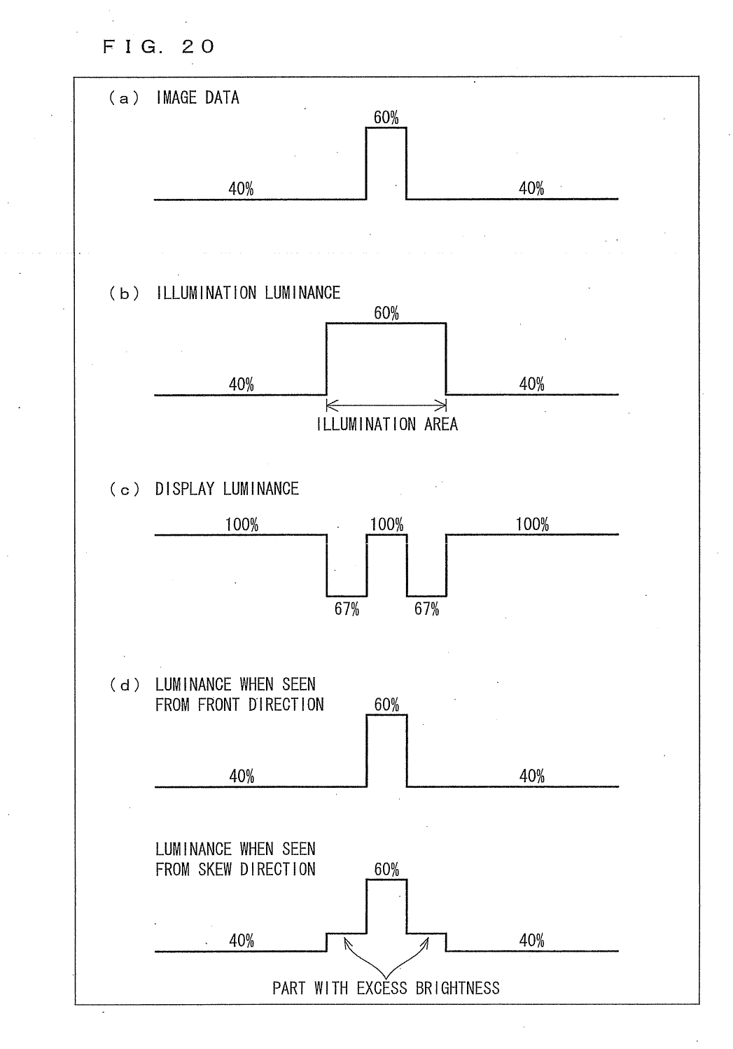

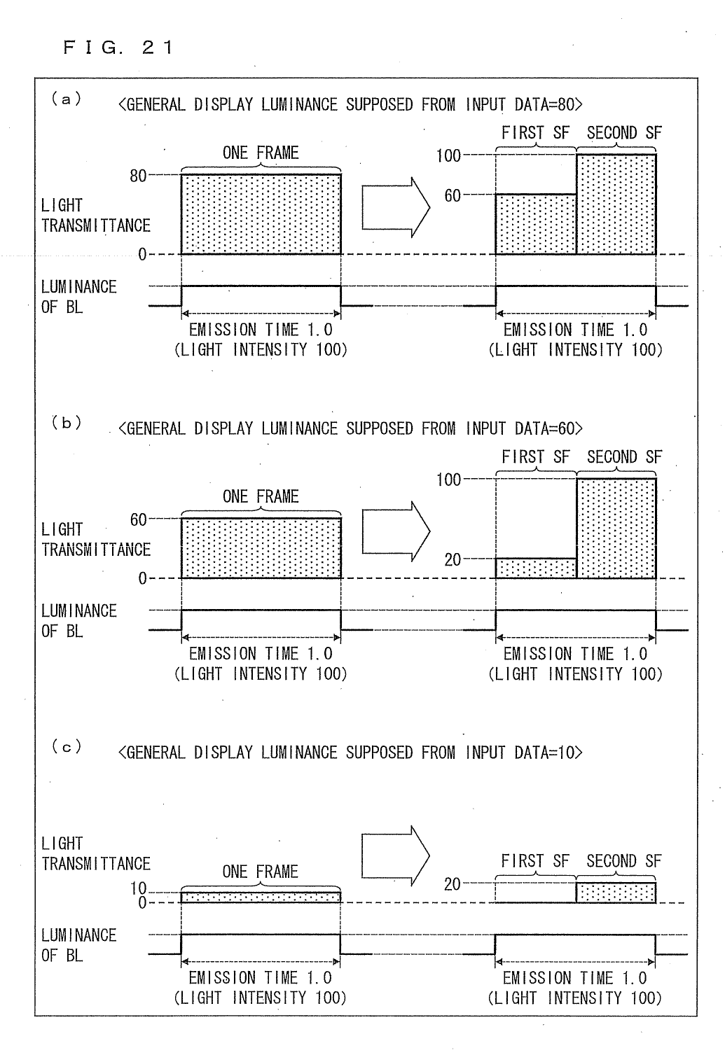

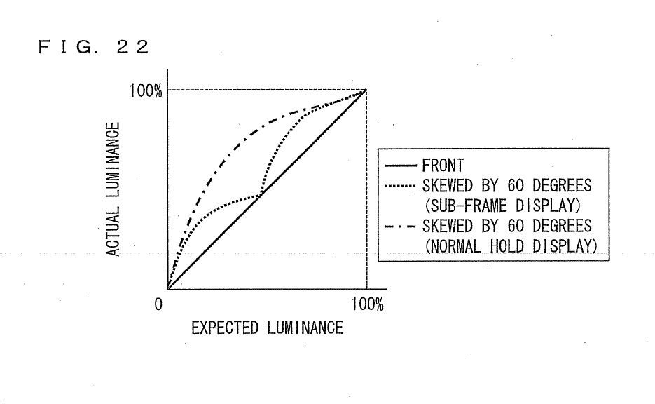

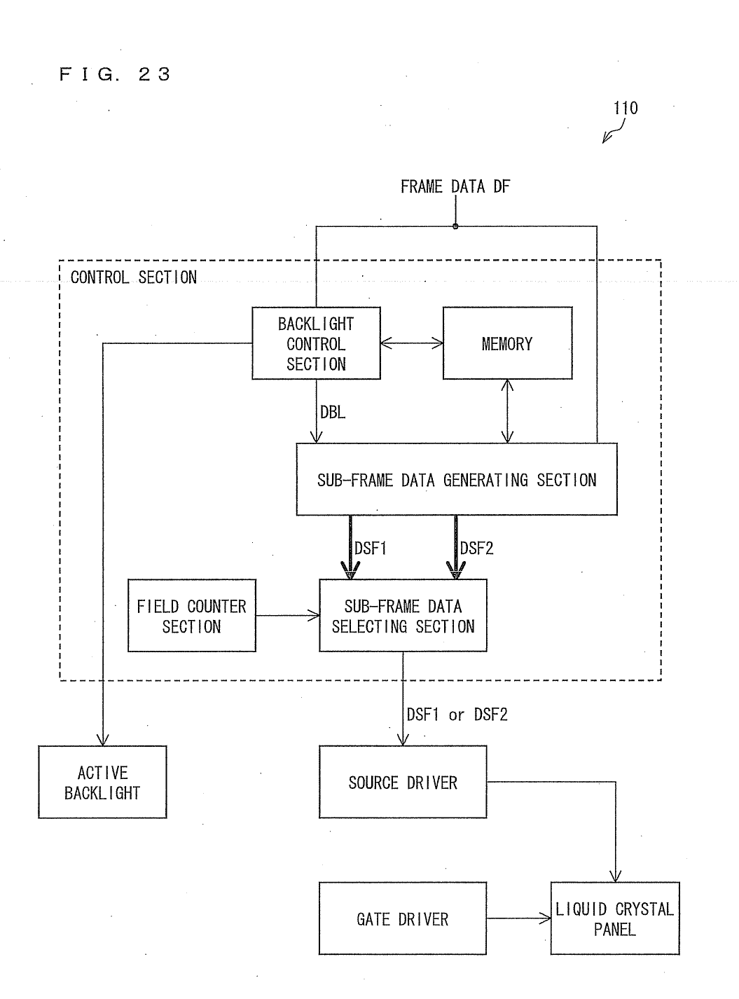

FIG. 16 is a block diagram showing a configuration of a liquid crystal display device in accordance with the present embodiment. As shown in FIG. 16, a liquid crystal display device 82 in accordance with the present embodiment includes an area active backlight (active backlight, backlight) 29, a liquid crystal panel 10, a gate driver 19, a source driver 3, and a control section 9. The liquid crystal panel 10 may be combined integrally with individual drivers (source driver 3 and gate driver 19).

As shown in FIG. 3, the area active backlight 29 includes a plurality of illumination areas LAR, and each illumination area LAR is designed such that light intensity per one frame can be controlled individually. As shown in FIG. 2, the liquid crystal panel 10 includes, in its display section, a plurality of display areas HAR respectively corresponding to illumination areas LAR of the area active backlight 29. For example, a display area HAR1 of the liquid crystal panel 10 corresponds to an illumination area LAR1 of the area active backlight 29.

The control section 9 of the liquid crystal display device 82 in accordance with the present embodiment includes a memory 6, a backlight control section 15, a sub-frame data generating section 22, a sub-frame data selecting control section 26, and a field counter section 35. The backlight control section 15 includes a display luminance determining section 16. To the backlight control section 15 and the sub-frame data generating section 22 is inputted frame data (input data) DF. The frame data DF is RGB data. Although not shown in the drawings, the control section 9 includes a timing control section to which a vertical sync signal, a horizontal sync signal, a dot clock etc. are inputted. The timing control section controls the backlight control section 15, the sub-frame data generating section 22, the sub-frame data selecting control section 26, the gate driver 19 etc.

The backlight control section 15 calculates, from all frame data DF included in a display area HAR, maximum display luminance and minimum display luminance which are supposed in the display area HAR, and the display luminance determining section 16 determines whether a difference between the maximum display luminance and the minimum display luminance (luminance difference) is larger than a predetermined threshold or not. The display luminance determining section 16 outputs the result of determination to the sub-frame data generating section 22. The threshold is a value serving as a reference for determining whether excess luminance appears or not. Since the threshold depends on optical characteristics of a liquid crystal panel in use and an optical system of a backlight in user, the threshold is evaluated and determined in individual systems and stored in the memory 6.

Further, the backlight control section 15 determines light intensity per one frame of the illumination area LAR corresponding to the display area HAR in accordance with the maximum display luminance, and outputs the determined light intensity as data DBL to the sub-frame data generating section 22. Further, the backlight control section 15 regulates (sets) light intensity per one frame of the illumination area LAR in accordance with the determined light intensity. In the liquid crystal display device 82 in accordance with the present embodiment, illumination luminance of the illumination area LAR is made constant, and light intensity per one frame of the illumination area LAR is regulated by changing an emission time in one frame (i.e. during what percentage of one frame emission is made).

The sub-frame data generating section 22 generates sub-frame data in accordance with the result of determination by the display luminance determining section 16. That is, when the difference between the minimum display luminance and the maximum display luminance (luminance difference) is larger than a predetermined threshold, it is highly likely that excess luminance appears. Accordingly, in order to carry out the “luminance dividing sub-frame display”, the sub-frame data generating section 22 generates first sub-frame data DSF1 and second sub-frame data DSF2 in accordance with the frame data DF and the light intensity (data DBL) per one frame of the illumination area LAR determined by the backlight control section 15.

The first sub-frame data DSF1 and the second sub-frame data DSF2 which have been generated by the sub-frame data generating section 22 are inputted to the sub-frame data selecting control section 26. The sub-frame data selecting control section 26 switches the first sub-frame data DSF1 and the second sub-frame data DSF2 at double speed (e.g. 120 Hz). The field counter section 35 determines whether in a first sub-frame or a second sub-frame, and outputs the result of determination to the sub-frame data selecting control section 26.

In accordance with the result of determination by the field counter section 35, the sub-frame data selecting control section 26 outputs the first sub-frame data DSF1 to the source driver 3 at start timing of the first sub-frame, and outputs the second sub-frame data DSF2 to the source driver 3 at start timing of the second sub-frame. Further, the sub-frame data selecting control section 26 outputs the dark sub-frame data and the bright sub-frame data to the source driver 3 in such a manner that the dark sub-frame data and the bright sub-frame data are switched with each other with respect to each frame. For example, during a first frame, dark sub-frame data is outputted to the source driver 3 at start timing of a first sub-frame, and bright sub-frame data is outputted to the source driver 3 at start timing of a second sub-frame. During a second frame, bright sub-frame data is outputted to the source driver 3 at start timing of a first sub-frame, and dark sub-frame data is outputted to the source driver 3 at start timing of a second sub-frame.

On the other hand, in a case where the difference between the minimum display luminance and the maximum display luminance (luminance difference) is not larger than the predetermined threshold, excess luminance is less likely to appear, and accordingly the “luminance equalizing sub-frame display” is carried out.

The source driver 3 converts the sub-frame data (DSF1 and DSF2) into analog potential signals, and drives individual source lines (data signal lines) of the liquid crystal panel 10 using the potential signals. Further, the gate driver 19 drives gate lines (scanning signal lines) of the liquid crystal panel 10.

How the sub-frame data generating section 22 sets light intensity per one frame of the illumination area LAR and how the sub-frame data generating section 22 generates the first sub-frame data DSF1 and the second sub-frame data DSf2 are the same as those in First Embodiment and explanations thereof are omitted here. How the first sub-frame data DSF1 and the second sub-frame data DSF2 generated by the sub-frame data generating section 22 are outputted to the source driver 3 is the same as that in Second Embodiment and explanations thereof are omitted here.

In the liquid crystal display device 82 in accordance with the present embodiment, in a display area for which the “luminance dividing sub-frame display” is carried out, a process in which dark sub-frame data and bright sub-frame data are switched with each other between a first sub-frame and a second sub-frame with respect to each of adjacent pixels is carried out. Whereas in a display area for which the “luminance equalizing sub-frame display” is carried out, a process in which dark sub-frame data and bright sub-frame data are switched with each other with respect to each of adjacent pixels is not carried out.

FIG. 17 is a drawing for explaining a process of partially carrying out the “luminance dividing sub-frame display” while switching dark sub-frame data and bright sub-frame data with each other with respect to each of adjacent pixels. (a) of FIG. 17 shows a part where excess luminance (excess brightness) is likely to appear due to large luminance difference. A state where excess luminance appears is shown for convenience of explanation. (b) of FIG. 17 shows a state in the first half of one frame (first sub-frame) of the part where excess luminance is likely to appear. (c) of FIG. 17 shows a state in the second half of one frame (second sub-frame) of the part where excess luminance is likely to appear. In the first sub-frame and the second sub-frame in (b) of FIG. 17 and (c) of FIG. 17, respectively, sub-frame data with low luminance and sub-frame data with high luminance are positioned in a zigzag manner so that sub-frame data with low luminance and sub-frame data with high luminance are switched with each other with respect to each of adjacent pixels. Consequently, luminances are averaged on a display plane as a whole. Therefore, a dark state or a bright state in each sub-frame is less likely to be observed as shown in (b) and (c) of FIG. 6. (d) of FIG. 17 shows a display state of one frame which is the sum of display in (b) of FIG. 17 and display in (c) of FIG. 17. As shown in (d) of FIG. 17, by partially carrying out the “luminance dividing sub-frame display” while switching dark sub-frame data and bright sub-frame data with each other with respect to each of adjacent pixels, it is possible to subdue excess luminance.

As described above, with the configuration of the liquid crystal display device 82 in accordance with the present embodiment, it is possible to make luminance difference between sub-frames less likely to be observed, compared with First and Second Embodiments.

### Fourth Embodiment

The following explains another embodiment of the liquid crystal display device of the present invention. For convenience of explanation, members having the same functions as those shown in First, Second, and Third Embodiments are given the same reference numerals. Terms defined in First, Second, and Third Embodiments are used with the same definitions in the present embodiment unless otherwise stated.

The liquid crystal display device in accordance with the present embodiment has a function of switching the driving methods shown in First, Second, and Third Embodiments, respectively. The driving method shown in First Embodiment (i.e. the “luminance dividing sub-frame display” is carried out with respect to only a display area where excess luminance is likely to appear) is referred to as “driving mode A”. The driving method shown in Second Embodiment (i.e. dark sub-frame data and bright sub-frame data are switched with each other with respect to each of adjacent pixels) is referred to as “driving mode B”. The driving method shown in Third Embodiment (i.e. switching of dark sub-frame data and bright sub-frame data with respect to each of adjacent pixels is carried out only for a display area with large luminance difference) is referred to as “driving mode C”. That is, the liquid crystal display device in accordance with the present embodiment switches the driving modes A-C in accordance with a state of frame data DF, instructions from a user of the liquid crystal display device etc.

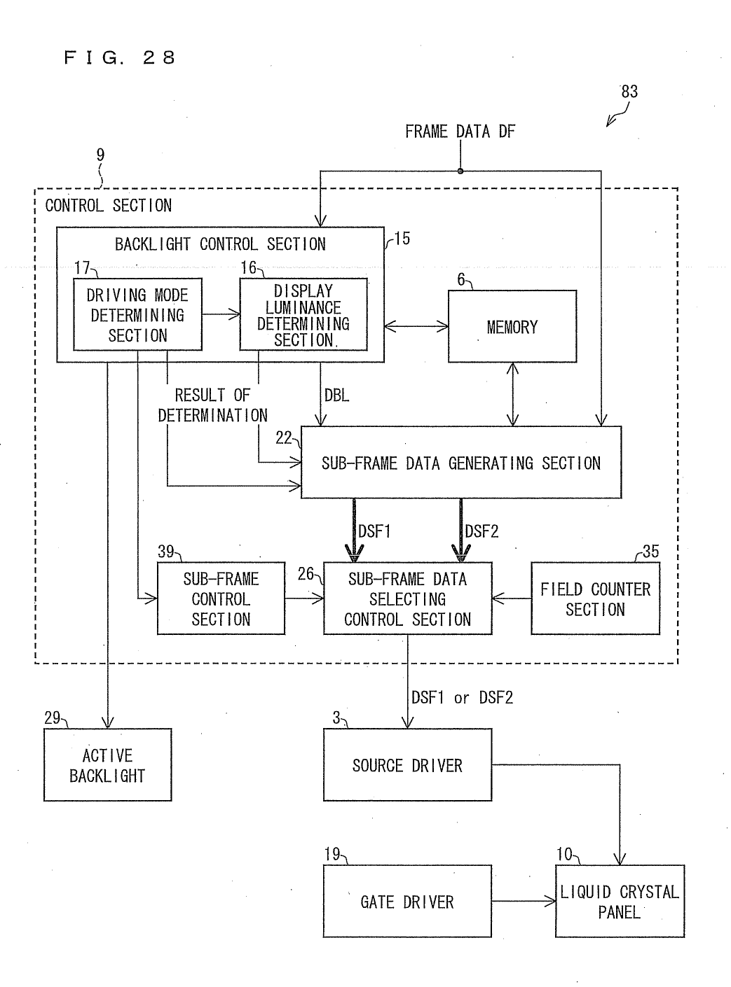

FIG. 28 is a block diagram showing a configuration of the liquid crystal display device in accordance with the present embodiment. As shown in FIG. 28, a liquid crystal display device 83 in accordance with the present embodiment includes an area active backlight (active backlight, backlight) 29, a liquid crystal panel 10, a gate driver 19, a source driver 3, and a control section 9. The liquid crystal panel 10 may be combined integrally with individual drivers (source driver 3 and gate driver 19).

As shown in FIG. 3, the area active backlight 29 includes a plurality of illumination areas LAR, and each illumination area LAR is designed such that light intensity per one frame can be controlled individually. As shown in FIG. 2, the liquid crystal panel 10 includes, in its display section, a plurality of display areas HAR respectively corresponding to illumination areas LAR of the area active backlight 29. For example, a display area HAR1 of the liquid crystal panel 10 corresponds to an illumination area LAR1 of the area active backlight 29.

The control section 9 of the liquid crystal display device 83 in accordance with the present embodiment includes a memory 6, a backlight control section 15, a sub-frame data generating section 22, a sub-frame data selecting control section 26, a field counter section 35, and a sub-frame control section 39. The backlight control section 15 includes a display luminance determining section 16 and a driving mode determining section 17. To the backlight control section 15 is inputted an instruction to select a driving mode from outside. Further, to the backlight control section 15 and the sub-frame data generating section 22 is inputted frame data (input data) DF. The frame data DF is RGB data. Although not shown in the drawings, the control section 9 includes a timing control section to which a vertical sync signal, a horizontal sync signal, a dot clock etc. are inputted. The timing control section controls the backlight control section 15, the sub-frame data generating section 22, the sub-frame data selecting control section 26, the gate driver 19 etc.

The backlight control section 15 calculates, from all frame data DF included in a display area HAR, maximum display luminance and minimum display luminance which are supposed in the display area HAR, and determines light intensity per one frame of an illumination area LAR corresponding to the display area HAR in accordance with the maximum display luminance and the minimum display luminance, and outputs the determined light intensity as data DBL to the sub-frame data generating section 22. Further, the backlight control section 15 regulates (sets) light intensity per one frame of the illumination area LAR in accordance with the determined light intensity. In the liquid crystal display device 83 in accordance with the present embodiment, illumination luminance of the illumination area LAR is made constant, and light intensity per one frame of the illumination area LAR is regulated by changing an emission time in one frame (i.e. during what percentage of one frame emission is made).

Further, in the backlight control section 15, the driving mode determining section 17 receives an instruction entered by a user's operation (instruction to select a driving mode) and determines which of the driving modes A, B, and C the selected driving mode is. The driving mode determining section 17 outputs the result of determination to the display luminance determining section 16 and the sub-frame control section 39.

In a case where the driving mode is “A” or “C”, the display luminance determining section 16 determines whether the difference between maximum display luminance and minimum display luminance (luminance difference) is larger than a predetermined threshold or not, and outputs the result of determination to the sub-frame data generating section 22. In a case where the driving mode is “B”, the display luminance determining section 16 does not carry out the determination process and informs the sub-frame data generating section 22 that the driving mode is “B”.

The sub-frame data generating section 22 carries out a process of generating sub-frame data as follows, in accordance with the result of determination by the display luminance determining section 16.

In a case where the difference between the maximum display luminance and the minimum display luminance (luminance difference) is larger than the predetermined threshold, excess luminance is likely to appear. Accordingly, the sub-frame data generating section 22 generates first sub-frame data DSF1 and second sub-frame data DSF2 for carrying out the “luminance dividing sub-frame display”. On the other hand, in a case where the difference between the maximum display luminance and the minimum display luminance (luminance difference) is not larger than the predetermined threshold, excess luminance is less likely to appear. Accordingly, the sub-frame data generating section 22 generates first sub-frame data DSF1 and second sub-frame data DSF2 for carrying out the “luminance equalizing sub-frame display”.

In a case where the sub-frame data generating section 22 receives from the display luminance determining section 16 the result of determination stating that the driving mode is “B”, the sub-frame data generating section 22 generates first sub-frame data DSF1 and second sub-frame data DSF2 for carrying out the “luminance dividing sub-frame display”.

The first sub-frame data DSF1 and the second sub-frame data DSF2 generated by the sub-frame data generating section 22 are inputted to the sub-frame data selecting control section 26.

In accordance with the result of determination by the driving mode determining section 17 and the result of determination by the field counter section 35 which results are obtained via the sub-frame control section 39, the sub-frame data selecting control section 26 carries out a process of outputting the first sub-frame data DSF1 and the second sub-frame data DSF2 obtained from the sub-frame data generating section 22.

In a case where the driving mode is “A”, during each frame, the sub-frame data selecting control section 26 outputs, to the source driver 3, the first sub-frame data DSF1 at start timing of a first sub-frame and the second sub-frame data DSF2 at start timing of a second sub-frame.

In a case where the driving mode is “B” or “C”, during a first frame, for a first pixel, the sub-frame data selecting control section 26 outputs, to the source driver 3, dark sub-frame data at start timing of a first sub-frame and bright sub-frame data at start timing of a second sub-frame, whereas for a second pixel, the sub-frame data selecting control section 26 outputs, to the source driver 3, bright sub-frame data at start timing of a first sub-frame and dark sub-frame data at start timing of a second sub-frame. During second and subsequent frames, the process for the first pixel and the process for the second pixel are switched with each other with respect to each frame.

In a case where the display luminance determining section 16 determines that the luminance difference is not larger than the threshold, during each frame, the sub-frame data selecting control section 26 outputs, to the source driver 3, first sub-frame data DSF1 at start timing of a first sub-frame and second sub-frame data DSF2 at start timing of a second sub-frame.

The source driver 3 converts the sub-frame data (DSF1 and DSF2) into analog potential signals, and drives individual source lines (data signal lines) of the liquid crystal panel 10 using the potential signals. Further, the gate driver 19 drives gate lines (scanning signal lines) of the liquid crystal panel 10.

How the sub-frame data generating section 22 sets light intensity per one frame of the illumination area LAR and how the first sub-frame data DSF1 and the second sub-frame data DSF2 are generated in the driving modes A-C and how the first sub-frame data DSF1 and the second sub-frame data DSF2 are outputted to the source driver 3 are the same as those in First to Third Embodiments and explanations thereof are omitted here.

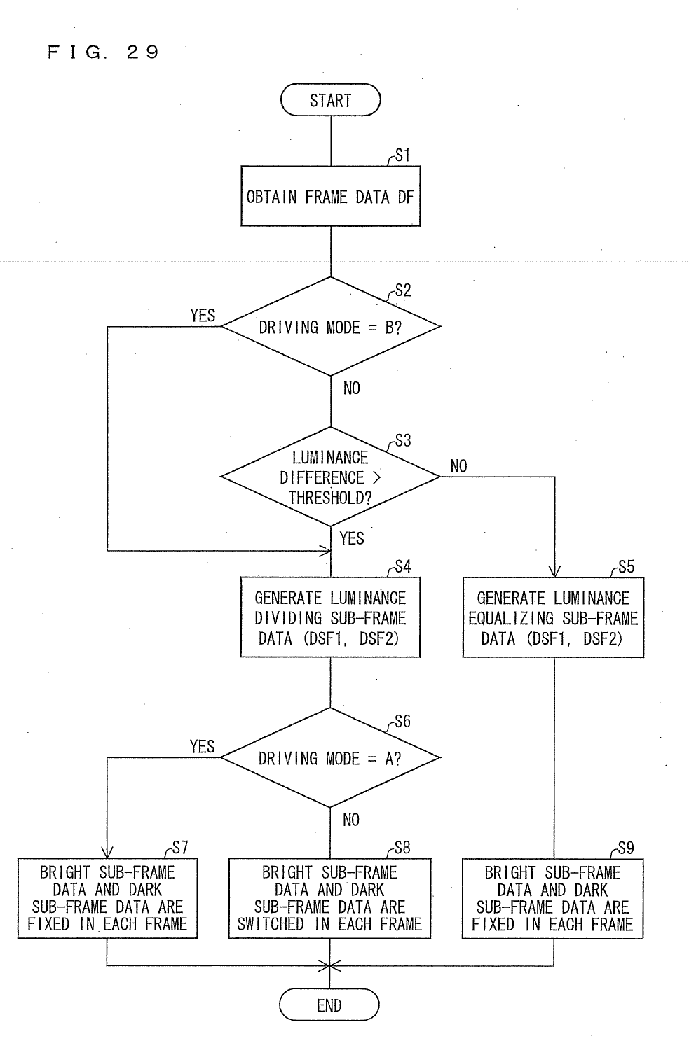

FIG. 29 is a flowchart showing an example of an operation of the liquid crystal display device 83 in accordance with the present embodiment. Initially, in step S1, frame data DF is inputted to the backlight control section 15 and the sub-frame data generating section 22. In the backlight control section 15, the driving mode determining section 17 determines which of “A”, “B”, and “C” the driving mode selected by a user is. Here, the driving mode determining section 17 determines whether the driving mode is “B” or not (S2).

In a case where the driving mode is not “B” (NO in S2), that is, in a case where the driving mode is “A” or “C”, the display luminance determining section 16 of the backlight control section 15 determines whether a difference between maximum display luminance and minimum display luminance (luminance difference) of the obtained frame data DF is larger than a predetermined threshold or not (S3).

In a case where the luminance difference is larger than the threshold (YES in S3), the sub-frame data generating section 22 generates first sub-frame data DSF1 and second sub-frame data DSF2 for luminance dividing sub-frame display (S4). On the other hand, in a case where the luminance difference is not larger than the threshold (NO in S3), the sub-frame data generating section 22 generates first sub-frame data DSF1 and second sub-frame data DSF2 for luminance equalizing sub-frame display (S5).

In a case where the driving mode is “B” (YES in S2), the display luminance determining section 16 of the backlight control section 15 does not carry out the determination process (luminance difference>threshold?) and the sub-frame data generating section 22 generates first sub-frame data DSF1 and second sub-frame data DSF2 for luminance dividing sub-frame display (S4).

Subsequently, the sub-frame data selecting control section 26 obtains the result of determination by the driving mode determining section 17 from the sub-frame control section 39 and determines whether the driving mode is “A” or not (S6). In a case where the driving mode is “A” (YES in S6), the sub-frame data selecting control section 26 outputs, to the source driver 3, the first sub-frame data DSF1 and the second sub-frame data DSF2 for the luminance dividing sub-frame display which are obtained from the sub-frame data generating section 22 at timing specified by the field counter section 35 (S7). That is, the sub-frame data selecting control section 26 outputs, to the source driver 3, the first sub-frame data DSF1 at start timing of a first sub-frame and the second sub-frame data DSF2 at start timing of a second sub-frame.

On the other hand, in a case where the driving mode is not “A” (NO in S6), that is, in a case where the driving mode is “B” or “C”, the sub-frame data selecting control section 26 outputs, to the source driver 3, the first sub-frame data DSF1 and the second sub-frame data DSF2 for the luminance dividing sub-frame display which are obtained from the sub-frame data generating section 22 at timing specified by the field counter section 35 (S8). That is, for a first pixel, the sub-frame data selecting control section 26 outputs, to the source driver 3, dark sub-frame data at start timing of a first sub-frame and bright sub-frame data at start timing of a second sub-frame, whereas for a second pixel, the sub-frame data selecting control section 26 outputs, to the source driver 3, bright sub-frame data at start timing of a first sub-frame and dark sub-frame data at start timing of a second sub-frame. In the next frame, sub-frame data for the first pixel and sub-frame data for the second pixel are switched with each other.

In a case of NO in S3 (the luminance difference is not larger than the threshold), the sub-frame data selecting control section 26 outputs, to the source driver 3, first sub-frame data DSF1 and second sub-frame data DSF2 for the luminance equalizing sub-frame display which are obtained from the sub-frame data generating section 22 at timing specified by the field counter section 35 (S9). That is, the sub-frame data selecting control section 26 outputs, to the source driver 3, first sub-frame data DSF1 at start timing of a first sub-frame and second sub-frame data DSF2 at start timing of a second sub-frame.

With the above operation, it is possible to switch to the mode selected by a user with respect to each frame.

Here, the present invention may be arranged such that the driving modes are switched automatically instead of according to the user's selection. For example, when the number of display areas HAR whose luminance difference in data per one frame is larger than the threshold is larger than the predetermined number of areas in whole display areas per one frame, the driving mode is switched to “B”, whereas when the number of such display areas HAR is not larger than the predetermined threshold, the driving mode is switched to “C”. This enables switching the driving modes with respect to each frame according to the number of display areas HAR likely to have excess luminance. For example, if the number of display areas likely to have excess luminance is large, the process according to the driving mode “B” (bright sub-frame data and dark sub-frame data are switched with each other with respect to each frame and each of adjacent two pixels) makes display operation complicated. Accordingly, in this case, the process according to the driving mode “C” (only a part of the process according to the driving mode “B” is carried out) is carried out. This enables simplifying the display operation.

In the liquid crystal display device with the above arrangement, frame data DF per one frame is stored in the memory 6 and the backlight control section 15 refers to the frame data DF per one frame and determines whether the number of display areas HAR whose luminance difference is larger than the threshold is larger than the predetermined number of areas. Alternatively, the present invention may be arranged such that frame data DF per one frame is not stored in the memory 6 and the backlight control section 15 counts the number of display areas HAR whose luminance is larger than the threshold with respect to each frame data DF inputted, and determines whether the number of such display areas HAR is larger than the predetermined number of areas or not. The liquid crystal display device with the above arrangement has the same configuration as that in FIG. 28 except for this point. In the liquid crystal display device with the above arrangement, in step S2 in FIG. 29, the driving mode determining section 17 determines the driving mode in accordance with the result of the determination, and thereafter carries out the processes in step S3 and subsequent steps.

The driving modes in the above arrangement have three patterns “A”, “B”, and “C”. The present invention is not limited to this case, and the driving modes may have other driving modes such as conventional frame display drive and sub-frame display drive, and the driving modes may be switched among them.

The following explains a television receiver 100 including one of the liquid crystal display devices in accordance with First to Fourth Embodiments. In a case where the liquid crystal display device displays an image according to television broadcasting, the liquid crystal display device (in FIG. 18, the liquid crystal display device 80 is shown as an example) is provided with a tuner section 10 so as to constitute the television receiver 100. The tuner section 10 extracts, from signal waves (high-frequency signals) received via an antenna (not shown), a signal of a channel to be received and converts the signal into a signal with intermediate frequency, and demodulates the signal with intermediate frequency so as to extract a composite color video signal Scv as a television signal. The composite color video signal Scv is inputted to the liquid crystal display device as described above, and an image based on the composite color video signal Scv is displayed by the liquid crystal display device.

Lastly, individual sections of the control section 9 of the liquid crystal display devices in accordance with First to Fourth Embodiments, particularly the backlight control section 15, the sub-frame data generating section 22, the sub-frame data selecting section 25, and the sub-frame data selecting control section 26 may be constituted by hardware logic or may be realized by software using CPU as follows.

Namely, the liquid crystal display devices in accordance with First to Forth Embodiments include: CPUs (central processing unit) for executing a control program for realizing each function; ROMs (read only memory) that store the program; RAMs (random access memory) that develop the program; storage devices (storage media) such as memories for storing the program and various data; and the like. The object of the present invention can be realized in such a manner that the liquid crystal display device is provided with a computer-readable storage medium for storing program codes (such as executable program, intermediate code program, and source program) of an electronic device control program which serves as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a Floppy Disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the liquid crystal display devices may be arranged so as to be connectable to a communication network so that the program code is supplied to the liquid crystal display devices through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

As described above, the liquid crystal display devices may be realized by a computer. In this case, a control program for individual devices which causes a computer to function as individual blocks so as to realize the liquid crystal display devices by the computer, and a computer-readable storage medium in which the control program is stored, are also encompassed in the scope of the present invention.

In order to solve the foregoing problem, a display device of the present invention is a display device, which generates, from input data, a plurality of sub-frame data respectively corresponding to a plurality of sub-frames obtained by dividing one frame, and which displays the input data as a sum of displays of the plurality of sub frame data, the display device including: a backlight including a plurality of illumination areas and capable of individually controlling light intensities of the plurality of illumination areas according to input data; a backlight control section for determining light intensity of each of the illumination areas according to input data to a display area corresponding to said each of the illumination areas and controlling the light intensity of said each of the illumination areas; and a sub-frame data generating section for generating the plurality of sub-frame data according to the light intensity of each of the illumination areas determined by the backlight control section, one frame being divided into a first sub-frame and a second sub-frame, the sub-frame data generating section generating first sub-frame data and second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

With the display device carrying out sub-frame display, for example, at a first pixel, a first half of a frame is a dark sub-frame and a second half of the frame is a bright sub-frame, whereas at a second pixel adjacent to the first pixel, the first half of the frame is a bright sub-frame and the second half of the frame is a dark sub-frame. Consequently, a difference between (i) an average of display luminances (brightness and darkness) on the whole of a display plane of a display panel in the first half of one frame and (ii) an average of display luminances (brightness and darkness) on the whole of the display plane of the display panel in the second half of the frame is smaller than that in the case of carrying out the sub-frame display on the whole of the display plane of the display panel (see FIG. 25). Consequently, luminance difference between sub-frames is less likely to be observed.

Consequently, the display device yields not only the effects of improving moving image quality and reducing power consumption due to sub-frame display but also the effect of improving display quality due to reduction in flickers. That is, the display device can simultaneously achieve improvement in moving image quality, reduction in power consumption, and improvement in display quality due to reduction in flickers.

In order to solve the foregoing problem, a display device of the present invention is a display device, including: a backlight including a plurality of illumination areas and capable of individually controlling light intensities of the plurality of illumination areas according to input data; a display luminance determining section for determining whether a difference between maximum display luminance and minimum display luminance of input data per one frame to each of display areas respectively corresponding to the illumination areas is larger than a predetermined threshold or not; a backlight control section for determining light intensity of each of the illumination areas according to input data per one frame to a display area corresponding to said each of the illumination areas and controlling the light intensity of said each of the illumination areas; and a sub-frame data generating section for generating, from input data, a plurality of sub-frame data respectively corresponding to a plurality of sub-frames obtained by dividing one frame, the generating being made according to a result of determination by the display luminance determining section and the light intensity of each of the illumination areas determined by the backlight control section, in a case where the difference between maximum display luminance and minimum display luminance of input data per one frame to the display area is larger than the threshold, a plurality of sub-frame data with different display luminances for the display area being generated from the input data according to the light intensity of each of the illumination areas determined by the backlight control section, and the input data being displayed as a sum of displays of the generated plurality of sub-frame data, and in a case where the difference between maximum display luminance and minimum display luminance of input data per one frame to the display area is not larger than the threshold, a plurality of sub-frame data with equal display luminance for the display area being generated from the input data according to the light intensity of each of the illumination areas determined by the backlight control section, and the input data being displayed as a sum of displays of the generated plurality of sub-frame data.

With the arrangement, with respect to a display area where a difference between maximum display luminance and minimum display luminance (luminance difference) of input data is larger than the predetermined threshold out of a plurality of display areas, light intensity of a corresponding illumination area is controlled to be intensity sufficient for display at the display area, and based on the controlled light intensity, a plurality of sub-frame data are generated such that individual sub-frames have different display luminances, and display is performed as a sum of these sub-frame data (luminance dividing sub-frame display). On the other hand, with respect to a display area where the luminance difference is not larger than the predetermined threshold, the luminance dividing sub-frame display is not carried out and instead a plurality of sub-frame data is generated such that individual sub-frames have equal display luminance and display is performed as a sum of these sub-frame data (luminance equalizing sub-frame display).

The threshold is a value serving as a reference for determining whether excess luminance appears or not. For example, assume that when a difference in luminance (light transmittance) between a bright part and a dark part in input data to a display area is 20%, excess luminance does not appear, and when the difference is more than 20%, excess luminance appears. In this case, the threshold is set to 20%. The threshold is determined according to optical characteristics of a liquid crystal panel in use and an optical system of a backlight in use.

That is, with the arrangement, with respect to a display area where excess luminance is likely to appear, the luminance dividing sub-frame display is carried out, whereas with respect to a display area where excess luminance is less likely to appear, the luminance equalizing sub-frame display is carried out. consequently, a luminance difference between sub-frames is less likely to be observed compared with a display state where the sub-frame display (luminance dividing sub-frame display) is carried out on the whole of a display plane of a display panel (see FIG. 25). Consequently, the display device yields not only the effects of improving moving image quality and reducing power consumption due to the luminance dividing sub-frame display but also the effect of improving display quality due to reduction in flickers. That is, the display device can simultaneously achieve improvement in moving image quality, reduction in power consumption, and improvement in display quality due to reduction in flickers.

The display device of the present invention may be arranged such that one frame is divided into a first sub-frame and a second sub-frame, and the sub-frame data generating section generates first sub-frame data and second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

The display device of the present invention may be arranged such that the backlight control section determines the light intensity of each of the illumination areas according to maximum display luminance of input data to each display area. This enables yielding the above effects while appropriately expressing a high luminance part in each display area.

The display device of the present invention may be arranged such that the backlight control section determines light intensity per one frame of each of the illumination areas and, based on the determined light intensity, controls light intensity per one frame of said each of the illumination areas.

With the arrangement, light intensity per one frame of each of the illumination areas can be controlled by changing an emission time of said each of the illumination areas while maintaining illumination luminance of said each of the illumination areas. For example, in a case where light intensity per one frame of an illumination area is to be maximized, the illumination area is put in an emission state throughout one frame. Otherwise, the illumination area is put in a non-emission state (for a continuous period of time) during one frame and then put in an emission state (for a continuous period of time) during that frame, or the illumination area is put in an emission state (for a continuous period of time) during one frame and then put in a non-emission state (for a continuous period of time) during that frame. Consequently, during a part of a dark sub-frame or throughout the dark sub-frame, a corresponding illumination area can be put in a non-emission state, thereby further increasing the above effects.

The display device of the present invention may be arranged such that the backlight control section controls the light intensity per one frame of each of the illumination areas by changing an emission time of said each of the illumination areas while maintaining illumination luminance of said each of the illumination areas.

The display device of the present invention may be arranged such that in a case where the light intensity per one frame of the illumination area is to be maximized, the backlight control section causes the illumination area to be in an emission state throughout said one frame, and in a case where the light intensity per one frame of the illumination area is not to be maximized, the backlight control section causes the illumination area to be in a non-emission state and thereafter in an emission state in said one frame or causes the illumination area to be in an emission state and thereafter in a non-emission state in said one frame.

The display device of the present invention may be arranged such that one frame is divided into a first sub-frame and a second sub-frame, the backlight control section determines light intensity per one frame of each of the illumination areas and, based on the determined light intensity, controls light intensity per one frame of said each of the illumination areas by changing an emission time of said each of the illumination areas while maintaining illumination luminance of said each of the illumination areas, in a case where the light intensity per one frame of the illumination area is not to be maximized, the backlight control section causes one of adjacent pixels to be in a non-emission state during at least a part of the first sub-frame and causes the other of the adjacent pixels to be in a non-emission state during at least a part of the second sub-frame, and the sub-frame data generating section generates the first sub-frame data and the second sub-frame data in such a manner that at said one of the adjacent pixels, display luminance during the first sub-frame is not higher than display luminance during the second sub-frame and at said the other of the adjacent pixels, display luminance during the second sub-frame is not higher than display luminance during the first sub-frame. Thus, the above effects can be yielded in the sub-frame display where one frame is divided into two sub-frames.

The display device of the present invention may be arranged such that in an odd frame, the sub-frame data generating section generates the first sub-frame data and the second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame, and in an even frame, the sub-frame data generating section generates the first sub-frame data and the second sub-frame data in such a manner that at said one of the adjacent pixels, display luminance during the second sub-frame is not higher than display luminance during the first sub-frame and at said the other of the adjacent pixels, display luminance during the first sub-frame is not higher than display luminance during the second sub-frame.

The display device of the present invention may be arranged such that one frame is divided into a first sub-frame and a second sub-frame, the backlight control section determines light intensity per one frame of each of the illumination areas and, based on the determined light intensity, controls light intensity per one frame of said each of the illumination areas by changing an emission time of said each of the illumination areas while maintaining illumination luminance of said each of the illumination areas, in a case where the light intensity per one frame of the illumination area is not to be maximized, the backlight control section causes the illumination area to be in a non-emission state during at least a part of the first sub-frame, and the sub-frame data generating section generates the first sub-frame data and the second sub-frame data in such a manner that display luminance during the first sub-frame is not higher than display luminance during the second sub-frame. Thus, the above effects can be yielded in the sub-frame display where one frame is divided into two sub-frames.

A liquid crystal display device of the present invention includes any one of the aforementioned display devices.

In order to solve the foregoing problem, a method of the present invention for driving a display device is a method for driving a display device which includes a backlight including a plurality of illumination areas and capable of individually controlling light intensities of the plurality of illumination areas according to input data and which generates, from input data, a plurality of sub-frame data respectively corresponding to a plurality of sub-frames obtained by dividing one frame, and which displays the input data as a sum of displays of the plurality of sub frame data, the method including: a backlight control step of determining light intensity of each of the illumination areas according to input data to a display area corresponding to said each of the illumination areas and controlling the light intensity of said each of the illumination areas; and a sub-frame data generating step of generating the plurality of sub-frame data according to the light intensity of each of the illumination areas determined in the backlight control step, one frame being divided into a first sub-frame and a second sub-frame, in the sub-frame data generating step, first sub-frame data and second sub-frame data being generated in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

The method yields the effects yielded by the display device of the present invention.

In order to solve the foregoing problem, a method of the present invention for driving a display device is a method for driving a display device including a backlight including a plurality of illumination areas and capable of individually controlling light intensities of the plurality of illumination areas according to input data, the method including: a display luminance determining step of determining whether a difference between maximum display luminance and minimum display luminance of input data per one frame to each of display areas respectively corresponding to the illumination areas is larger than a predetermined threshold or not; a backlight control step of determining light intensity of each of the illumination areas according to input data per one frame to a display area corresponding to said each of the illumination areas and controlling the light intensity of said each of the illumination areas; and a sub-frame data generating step of generating, from input data, a plurality of sub-frame data respectively corresponding to a plurality of sub-frames obtained by dividing one frame, the generating being made according to a result of determination in the display luminance determining step and the light intensity of said each of the illumination areas determined in the backlight control step, in a case where the difference between maximum display luminance and minimum display luminance of input data per one frame to the display area is larger than the threshold, a plurality of sub-frame data with different display luminances for the display area being generated from the input data according to the light intensity of said each of the illumination areas determined in the backlight control step, and the input data being displayed as a sum of displays of the generated plurality of sub-frame data, and in a case where the difference between maximum display luminance and minimum display luminance of input data per one frame to the display area is not larger than the threshold, a plurality of sub-frame data with equal display luminance for the display area being generated from the input data according to the light intensity of said each of the illumination areas determined in the backlight control step, and the input data being displayed as a sum of displays of the generated plurality of sub-frame data.

The method yields the effects yielded by the display device of the present invention.

A television receiver of the present invention includes: any one of the aforementioned display devices; and a tuner section for receiving television broadcasting.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The display device of the present invention is preferably applicable to a liquid crystal television for example.

### REFERENCE SIGNS LIST

3: Source driver
6: Memory
9: Control section
10: Liquid crystal panel
   15: Backlight control section
16: Display luminance determining section
17: Driving mode determining section
19: Gate driver
22: Sub-frame data generating section
25: Sub-frame data selecting section
26: Sub-frame data selecting control section
29: Area active backlight (active backlight, backlight)
80, 81, 82, 83: Liquid crystal display device (display device)
DF: Frame data
DSF1: First sub-frame data
DSF2: Second sub-frame data
HAR: Display area
LAR: Illumination area

1. A display device, which generates, from input data, a plurality of sub-frame data respectively corresponding to a plurality of sub-frames obtained by dividing one frame, and which displays the input data as a sum of displays of the plurality of sub frame data,
the display device comprising:
a backlight including a plurality of illumination areas and capable of individually controlling light intensities of the plurality of illumination areas according to input data;
a backlight control section for determining light intensity of each of the illumination areas according to input data to a display area corresponding to said each of the illumination areas and controlling the light intensity of said each of the illumination areas; and
a sub-frame data generating section for generating the plurality of sub-frame data according to the light intensity of each of the illumination areas determined by the backlight control section,
one frame being divided into a first sub-frame and a second sub-frame,
the sub-frame data generating section generating first sub-frame data and second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

2. A display device, comprising:
a backlight including a plurality of illumination areas and capable of individually controlling light intensities of the plurality of illumination areas according to input data;
a display luminance determining section for deter mining whether a difference between maximum display luminance and minimum display luminance of input data per one frame to each of display areas respectively corresponding to the illumination areas is larger than a predetermined threshold or not;
a backlight control section for determining light intensity of each of the illumination areas according to input data per one frame to a display area corresponding to said each of the illumination areas and controlling the light intensity of said each of the illumination areas; and
a sub-frame data generating section for generating, from input data, a plurality of sub-frame data respectively corresponding to a plurality of sub-frames obtained by dividing one frame, the generating being made according to a result of determination by the display luminance determining section and the light intensity of each of the illumination areas determined by the backlight control section,
in a case where the difference between maximum display luminance and minimum display luminance of input data per one frame to the display area is larger than the threshold, a plurality of sub-frame data with different display luminances for the display area being generated from the input data according to the light intensity of each of the illumination areas determined by the backlight control section, and the input data being displayed as a sum of displays of the generated plurality of sub-frame data, and
in a case where the difference between maximum display luminance and minimum display luminance of input data per one frame to the display area is not larger than the threshold, a plurality of sub-frame data with equal display luminance for the display area being generated from the input data according to the light intensity of each of the illumination areas determined by the backlight control section, and the input data being displayed as a sum of displays of the generated plurality of sub-frame data.

3. The display device as set forth in claim 2, wherein
one frame is divided into a first sub-frame and a second sub-frame, and
the sub-frame data generating section generates first sub-frame data and second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

4. The display device as set forth in claim 1, wherein
the backlight control section determines the light intensity of each of the illumination areas according to maximum display luminance of input data to each display area.

5. The display device as set forth in claim 1, wherein
the backlight control section determines light intensity per one frame of each of the illumination areas and, based on the determined light intensity, controls light intensity per one frame of said each of the illumination areas.

6. The display device as set forth in claim 5, wherein
the backlight control section controls the light intensity per one frame of each of the illumination areas by changing an emission time of said each of the illumination areas while maintaining illumination luminance of said each of the illumination areas.

7. The display device as set forth in claim 6, wherein
in a case where the light intensity per one frame of the illumination area is to be maximized, the backlight control section causes the illumination area to be in an emission state throughout said one frame, and
in a case where the light intensity per one frame of the illumination area is not to be maximized, the backlight control section causes the illumination area to be in a non-emission state and thereafter in an emission state in said one frame or causes the illumination area to be in an emission state and thereafter in a non-emission state in said one frame.

8. The display device as set forth in claim 1, wherein
one frame is divided into a first sub-frame and a second sub-frame,
the backlight control section determines light intensity per one frame of each of the illumination areas and, based on the determined light intensity, controls light intensity per one frame of said each of the illumination areas by changing an emission time of said each of the illumination areas while maintaining illumination luminance of said each of the illumination areas,
in a case where the light intensity per one frame of the illumination area is not to be maximized, the backlight control section causes one of adjacent pixels to be in a non-emission state during at least a part of the first sub-frame and causes the other of the adjacent pixels to be in a non-emission state during at least a part of the second sub-frame, and
the sub-frame data generating section generates the first sub-frame data and the second sub-frame data in such a manner that at said one of the adjacent pixels, display luminance during the first sub-frame is not higher than display luminance during the second sub-frame and at said the other of the adjacent pixels, display luminance during the second sub-frame is not higher than display luminance during the first sub-frame.

9. The display device as set forth in claim 1, wherein
in an odd frame, the sub-frame data generating section generates the first sub-frame data and the second sub-frame data in such a manner that at one of adjacent pixels, display luminance during the first sub-frame is not higher than display luminance during the second sub-frame and at the other of the adjacent pixels, display luminance during the second sub-frame is not higher than display luminance during the first sub-frame, and
in an even frame, the sub-frame data generating section generates the first sub-frame data and the second sub-frame data in such a manner that at said one of the adjacent pixels, display luminance during the second sub-frame is not higher than display luminance during the first sub-frame and at said the other of the adjacent pixels, display luminance during the first sub-frame is not higher than display luminance during the second sub-frame.

10. The display device as set forth in claim 2, wherein
one frame is divided into a first sub-frame and a second sub-frame,
the backlight control section determines light intensity per one frame of each of the illumination areas and, based on the deter mined light intensity, controls light intensity per one frame of said each of the illumination areas by changing an emission time of said each of the illumination areas while maintaining illumination luminance of said each of the illumination areas,
in a case where the light intensity per one frame of the illumination area is not to be maximized, the backlight control section causes the illumination area to be in a non-emission state during at least a part of the first sub-frame, and
the sub-frame data generating section generates the first sub-frame data and the second sub-frame data in such a manner that display luminance during the first sub-frame is not higher than display luminance during the second sub-frame.

11. A liquid crystal display device, comprising a display device as set forth in claim 1.

12. A method for driving a display device which includes a backlight including a plurality of illumination areas and capable of individually controlling light intensities of the plurality of illumination areas according to input data and which generates, from input data, a plurality of sub-frame data respectively corresponding to a plurality of sub-frames obtained by dividing one frame, and which displays the input data as a sum of displays of the plurality of sub frame data,
the method comprising:
a backlight control step of determining light intensity of each of the illumination areas according to input data to a display area corresponding to said each of the illumination areas and controlling the light intensity of said each of the illumination areas; and
a sub-frame data generating step of generating the plurality of sub-frame data according to the light intensity of each of the illumination areas determined in the backlight control step,
one frame being divided into a first sub-frame and a second sub-frame,
in the sub-frame data generating step, first sub-frame data and second sub-frame data being generated in such a manner that at one of adjacent pixels, display luminance during the first sub-frame is not higher than display luminance during the second sub-frame and at the other of the adjacent pixels, display luminance during the second sub-frame is not higher than display luminance during the first sub-frame.

13. A method for driving a display device including a backlight including a plurality of illumination areas and capable of individually controlling light intensities of the plurality of illumination areas according to input data,
the method comprising:
a display luminance determining step of determining whether a difference between maximum display luminance and minimum display luminance of input data per one frame to each of display areas respectively corresponding to the illumination areas is larger than a predetermined threshold or not;
a backlight control step of determining light intensity of each of the illumination areas according to input data per one frame to a display area corresponding to said each of the illumination areas and controlling the light intensity of said each of the illumination areas; and
a sub-frame data generating step of generating, from input data, a plurality of sub-frame data respectively corresponding to a plurality of sub-frames obtained by dividing one frame, the generating being made according to a result of determination in the display luminance determining step and the light intensity of said each of the illumination areas determined in the backlight control step,
in a case where the difference between maximum display luminance and minimum display luminance of input data per one frame to the display area is larger than the threshold, a plurality of sub-frame data with different display luminances for the display area being generated from the input data according to the light intensity of said each of the illumination areas determined in the backlight control step, and the input data being displayed as a sum of displays of the generated plurality of sub-frame data, and
in a case where the difference between maximum display luminance and minimum display luminance of input data per one frame to the display area is not larger than the threshold, a plurality of sub-frame data with equal display luminance for the display area being generated from the input data according to the light intensity of said each of the illumination areas determined in the backlight control step, and the input data being displayed as a sum of displays of the generated plurality of sub-frame data.

14. A television receiver, comprising:
a display device as set forth in claim 1; and
a tuner section for receiving television broadcasting.
